(19) United States
(12) Patent Application Publication
(10) Pub. No.: US 2022/0114145 A1
(43) Pub. Date: Apr. 14, 2022

(54) Resource Lock Management Method And Apparatus

(71) Applicant: HUAWEI TECHNOLOGIES CO., LTD., Shenzhen (CN)

(72) Inventor: Jun PIAO, Shenzhen (CN)

(21) Appl. No.: 17/557,926

(22) Filed: Dec. 21, 2021

Related U.S. Application Data
(63) Continuation of application No. PCT/CN2020/091650, filed on May 21, 2020.

(30) Foreign Application Priority Data
Jun. 26, 2019 (CN) 201910563273.X

(51) Int. Cl. G06F 16/176; G06F 16/182; G06F 9/50; G06F 9/52; G06F 15/173

(52) U.S. Cl. CPC G06F 16/1774; G06F 16/1824; G06F 15/17331; G06F 9/52; G06F 9/5016

(57) ABSTRACT

Example resource lock management methods and apparatus are provided. One example method includes obtaining resource lock information of a target resource by a first node, where the resource lock information represents whether a resource lock is added to the target resource, and information about a waiting node queue that requests to add a resource lock. The first node determines, based on the resource lock information, whether a first resource lock addition condition is met. If the first resource lock addition condition is met, the first node adds the resource lock to the target resource. If the first resource lock addition condition is not met, the first node queues to wait to add the resource lock, and updates the resource lock information. The first node monitors the resource lock information until it is determined that the resource lock information meets a second resource lock addition condition, adds the resource lock to the target resource, and updates the resource lock information.

### CROSS-REFERENCE TO RELATED APPLICATIONS

This application is a continuation of International Application No. PCT/CN2020/091650, filed on May 21, 2020, which claims priority to Chinese Patent Application No. 201910563273.X, filed on Jun. 26, 2019. The disclosures of the aforementioned applications are hereby incorporated by reference in their entireties.

### TECHNICAL FIELD

This application relates to the field of communications technologies, and in particular, to a resource lock management method and apparatus.

### BACKGROUND

A distributed file system includes a plurality of nodes. A file is stored on some nodes in a distributed manner, and other nodes may access the node through a network to perform a read/write operation on the file. The distributed file system may also be referred to as a shared storage-type file system.

In the distributed file system, a node may manage a file stored on another node by using a resource lock mechanism, to improve efficiency and security of file management. A resource lock includes an exclusive lock and a shared lock. A node may view, modify, and delete a file by adding an exclusive lock to the file, and after the exclusive lock is added to the file, no resource lock of any type can be added. When adding a shared lock to a file, a node may view the file but cannot modify or delete the file.

Currently, the distributed file system may use a distributed lock manager (distributed lock manager, DLM) technology of a decentralized architecture or a semi-distributed lock manager (semi-distributed lock manager, SDLM) technology of a centralized architecture, to implement lock addition and release management on the foregoing resource locks.

A technical principle of the DLM technology is to perform communication according to a transmission control protocol (transmission control protocol, TCP)/an internet protocol (internet protocol, IP), where the DLM is run on each computer in a cluster, and has a same copy as that of a cluster-wide lock database, to access shared resources synchronously.

A technical principle of the SDLM technology is that a storage server centrally processes lock requests, to access shared resources synchronously.

However, when management is performed on the distributed file system by using the foregoing two methods, a phenomenon that lock addition starves often occurs, that is, a node that needs to add a lock cannot perform a lock addition operation, and indefinitely waits.

In conclusion, during distributed system management in a conventional technology, there is a problem that lock addition starves on a lock addition node.

### SUMMARY

This application provides a resource lock management method and apparatus, to avoid a problem that lock addition starves on a lock addition node when management is performed in a distributed system in a conventional technology.

According to a first aspect, an embodiment of this application provides a resource lock management method, including:

A first node determines to add a resource lock to a target resource, and obtains resource lock information corresponding to the target resource. The resource lock information is used to represent whether the resource lock is added to the target resource, and information about a waiting node queue that requests to add the resource lock. A type of the resource lock is an exclusive lock or a shared lock. The first node determines, based on the resource lock information, whether a first resource lock addition condition is met. If the first resource lock addition condition is met, the first node adds the resource lock to the target resource, and updates the resource lock information, so that the updated resource lock information represents that the resource lock is added to the target resource. If the first resource lock addition condition is not met, the first node queues to wait to add the resource lock, and updates the resource lock information, so that the updated resource lock information represents that the first node has joined the waiting node queue, monitors the resource lock information, until it is determined that the resource lock information meets a second resource lock addition condition, adds the resource lock to the target resource, and updates the resource lock information, so that the updated resource lock information represents that the resource lock is added to the target resource, and the first node is deleted from the waiting node queue.

According to this solution, when adding the resource lock to the target resource, the first node performs a lock addition operation based on the resource lock information corresponding to the target resource. Whether the resource lock is currently added to the target resource and information about a node queue that requests to add the resource lock may be determined based on the resource lock information. This effectively resolves a problem that lock addition starves on a lock addition node when management is performed in a distributed system.

The “node” mentioned in this application may be a physical device, for example, a physical server, may be a virtualization device such as a virtual machine or a container, or may be considered as an element for computing processing in an operating system such as a thread or a process.

In a possible implementation, that the first node obtains the resource lock information corresponding to the target resource includes: The first node obtains, from the first node, the resource lock information corresponding to the target resource; or the first node obtains, from a second node, the resource lock information corresponding to the target resource.

According to this solution, in this application, the first node may locally obtain, the resource lock information corresponding to the target resource, or obtain, from the second node, the resource lock information corresponding to the target resource.

In a possible implementation, that the first node obtains, from the second node, the resource lock information corresponding to the target resource includes: The first node determines the second node that stores the target resource; and the first node obtains, from the second node, the resource lock information corresponding to the target resource.

According to this solution, this application describes in detail how the first node obtains, from the second node, the resource lock information corresponding to the target resource.

In a possible implementation, that the first node determines the second node that stores the target resource includes: The first node determines, based on a primary-secondary node mapping relationship, that a primary node of the first node is the second node.

According to this solution, this application provides a mapping rule between the first node and the second node, so that the first node determines the corresponding second node according to the mapping rule.

In a possible implementation, that the first node obtains, from the second node, the resource lock information corresponding to the target resource includes: The first node obtains, from the second node based on a remote direct memory access (remote direct memory access, RDMA) technology, the resource lock information corresponding to the target resource.

According to this solution, in this application, when resource lock management is performed in the distributed system, the RDMA technology may be used to greatly improve lock addition/release efficiency and reduce a delay.

In a possible implementation, the resource lock information includes exclusive lock indication information, the waiting node queue, and a quantity of shared nodes. The exclusive lock indication information is used to indicate whether an exclusive lock is added to the target resource. The quantity of shared nodes is a quantity of nodes that have added a shared lock to the target resource. The waiting node queue includes an identifier of a node that requests to add the resource lock to the target resource, and the identifier of the node in the waiting node queue is arranged in a sequence of requesting to add the resource lock.

According to this solution, in this application, the resource lock information is divided into the exclusive lock indication information, the waiting node queue, and the quantity of shared nodes, so that when performing a resource lock addition operation on the target resource, the first node may determine, based on the resource lock information, whether the exclusive lock or the shared lock is currently added to the target resource, a quantity of nodes that have added the shared lock, and whether there is a node that waits to add the resource lock to the target resource.

In a possible implementation, when the type of the resource lock is an exclusive lock, the first resource lock addition condition is as follows: The exclusive lock indication information indicates that no exclusive lock is added to the target resource, the quantity of shared nodes is 0, and the waiting node queue is empty; and the second resource lock addition condition is as follows: The exclusive lock indication information indicates that no exclusive lock is added to the target resource, the quantity of shared nodes is 0, and a node identifier of the first node is a first bit in the waiting node queue.

According to this solution, when performing an exclusive lock addition operation on the target resource, the first node may determine, based on the resource lock information corresponding to the target resource, whether a first exclusive lock addition condition is currently met, and directly perform the lock addition operation if the first exclusive lock addition condition is met; or if the first exclusive lock addition condition is not met, queue to wait to perform the exclusive lock addition operation in the sequence of requesting to add the resource lock to the target resource. In a process of queuing to wait, if determining that a second exclusive lock addition condition is met, the first node performs the exclusive lock addition operation on the target resource. It is clear that, according to the method, a case in which the first node that requests to add the exclusive clock in the waiting node queue is continuously stopped through a queue jump and preemption and cannot successfully perform lock addition for a long time can be effectively avoided, and a problem that lock addition starves on the first node can be resolved.

In a possible implementation, the resource lock information further includes a quantity of exclusive lock request nodes, and the quantity of exclusive lock request nodes is a quantity of nodes that request to add the exclusive lock in the waiting node queue. That the first node updates the resource lock information, so that the updated resource lock information represents that the first node has joined the waiting node queue includes: The first node adds the node identifier of the first node to the waiting node queue, and increases the quantity of exclusive lock request nodes by one. That the first node updates the resource lock information, so that the updated resource lock information represents that the resource lock is added to the target resource and that the first node is deleted from the waiting node queue includes: The first node updates the exclusive lock indication information, decreases the quantity of exclusive lock request nodes by one, and deletes the node identifier of the first node from the waiting node queue. The updated exclusive lock indication information indicates that the exclusive lock is added to the target resource.

According to this solution, in this application, the resource lock information further includes the quantity of exclusive lock request nodes, so that when performing the lock addition operation on the target resource, the first node may further determine, based on the resource lock information, a quantity of nodes that wait to add the exclusive lock to the target resource.

In a possible implementation, the waiting node queue further includes resource lock type indication information of each node. Resource lock type indication information of any node is used to indicate a type of a resource lock that the node requests to add. That the first node updates the resource lock information, so that the updated resource lock information represents that the first node has joined the waiting node queue includes: The first node adds the node identifier of the first node and exclusive lock indication information of the first node to the waiting node queue. That the first node updates the resource lock information, so that the updated resource lock information represents that the resource lock is added to the target resource and that the first node is deleted from the waiting node queue includes: The first node updates the exclusive lock indication information, and deletes the node identifier of the first node and the exclusive lock indication information of the first node from the waiting node queue. The updated exclusive lock indication information indicates that the exclusive lock is added to the target resource.

According to this solution, in this application, the waiting node queue further includes resource lock type indication information of each node. Resource lock type indication information of any node is used to indicate a type of a resource lock that the node requests to add. Therefore, the first node may determine, based on the waiting node queue in the resource lock information, a quantity of nodes that wait to add the shared lock to the target resource and a quantity of nodes that have added the exclusive lock. In a possible implementation, when the resource lock is a shared lock, the resource lock information further includes a quantity of exclusive lock request nodes, and the quantity of exclusive lock request nodes is a quantity of nodes that request to add the exclusive lock in the waiting node queue. The first resource lock addition condition is as follows: The exclusive lock indication information indicates that no exclusive lock is added to the target resource, and the quantity of exclusive lock request nodes is 0. The second resource lock addition condition is as follows: The exclusive lock indication information indicates that no exclusive lock is added to the target resource, and the node identifier of the first node is a first bit in the waiting node queue.

According to this solution, when performing a shared lock addition operation on the target resource, the first node may determine, based on the resource lock information corresponding to the target resource, whether a first shared lock addition condition is currently met, and directly perform the lock addition operation if the first shared lock addition condition is met; or if the first shared lock addition condition is not met, queue to wait to perform the shared lock addition operation in the sequence of requesting to add the resource lock to the target resource. In a process of queuing to wait, if determining that a second shared lock addition condition is met, the first node performs the shared lock addition operation on the target resource. It is clear that, according to the method, a case in which the first node that requests to add the shared clock in a waiting queue is continuously stopped through a queue jump and preemption and cannot successfully perform lock addition for a long time can be effectively avoided, and a problem that lock addition starves on the first node can be resolved.

In a possible implementation, that the first node updates the resource lock information, so that the updated resource lock information represents that the resource lock is added to the target resource includes: The first node increases the quantity of shared nodes by one.

That the first node updates the resource lock information, so that the updated resource lock information represents that the resource lock is added to the target resource and that the first node is deleted from the waiting node queue includes: The first node increases the quantity of shared nodes by one, and deletes the node identifier of the first node from the waiting node queue.

According to this solution, in this application, the first node may determine, based on the resource lock information, a quantity of nodes that currently add the shared lock to the target resource.

In a possible implementation, the resource lock information further includes a quantity of shared lock request nodes, and the quantity of shared lock request nodes is a quantity of nodes that request to add the shared lock in the waiting node queue. That the first node updates the resource lock information, so that the updated resource lock information represents that the first node has joined the waiting node queue includes: The first node adds the node identifier of the first node to the waiting node queue, and increases the quantity of shared lock request nodes by one. That the first node updates the resource lock information, so that the updated resource lock information represents that the resource lock is added to the target resource and that the first node is deleted from the waiting node queue includes: The first node increases the quantity of shared nodes by one, decreases the quantity of shared lock request nodes by one, and deletes the node identifier of the first node from the waiting node queue.

According to this solution, in this application, the resource lock information further includes the quantity of shared lock request nodes, so that when performing the lock addition operation on the target resource, the first node may further determine, based on the resource lock information, a quantity of nodes that wait to add the shared lock to the target resource.

In a possible implementation, when the resource lock is a shared lock, the waiting node queue further includes resource lock type indication information of each node. Resource lock type indication information of any node is used to indicate a type of a resource lock that the node requests to add. The first resource lock addition condition is as follows: The exclusive lock indication information indicates that no exclusive lock is added to the target resource, and the waiting node queue does not include a node whose corresponding resource lock type indication information indicates the exclusive lock. The second resource lock addition condition is as follows: The exclusive lock indication information indicates that no exclusive lock is added to the target resource, and the node identifier of the first node is a first bit in the waiting node queue.

According to this solution, in this application, the waiting node queue further includes resource lock type indication information of each node. Resource lock type indication information of any node is used to indicate a type of a resource lock that the node requests to add. Therefore, the first node may determine, based on the waiting node queue in the resource lock information, a quantity of nodes that wait to add the shared lock to the target resource and a quantity of nodes that have added the exclusive lock.

In a possible implementation, that the first node updates the resource lock information, so that the updated resource lock information represents that the resource lock is added to the target resource includes: The first node increases the quantity of shared nodes by one.

That the first node updates the resource lock information, so that the updated resource lock information represents that the resource lock is added to the target resource and that the first node is deleted from the waiting node queue includes: The first node increases the quantity of shared nodes by one, and deletes the node identifier of the first node and resource lock type indication information of the first node from the waiting node queue.

According to this solution, this application provides a method for updating the resource lock information when the waiting node queue further includes the resource lock type indication information of each node.

In a possible implementation, after the first node adds the exclusive lock to the target resource, the method further includes: The first node releases the exclusive lock from the target resource, and updates the exclusive lock indication information. The updated exclusive lock indication information indicates that no exclusive lock is added to the target resource.

According to this solution, this application provides a method for releasing, by the first node, the exclusive lock added to the target resource.

In a possible implementation, after the first node adds the shared lock to the target resource, the method further includes: The first node releases the shared lock from the target resource, and decreases the quantity of shared nodes by one.

According to this solution, this application provides a method for releasing, by the first node, the shared lock added to the target resource.

According to a second aspect, an embodiment of this application provides a resource lock management apparatus. The apparatus may be configured to perform an operation in any one of the first aspect or the possible implementations of the first aspect. For example, the apparatus may include a module/unit that is configured to perform each operation in any one of the first aspect or the possible implementations of the first aspect.

According to a third aspect, an embodiment of this application provides a resource lock management apparatus. The apparatus may be configured to perform an operation in any one of the first aspect or the possible implementations of the first aspect. The apparatus includes a transceiver and a storage. The processor may be configured to support the apparatus in performing a corresponding function of the first node, and the storage may store data used when the processor performs an operation. According to a fourth aspect, an embodiment of this application provides a chip system, including a processor, and optionally further including a storage. The storage is configured to store a computer program, and the processor is configured to: invoke the computer program from the storage, and run the computer program, so that a communications device on which the chip system is installed performs any method in any one of the first aspect or possible implementations of the first aspect.

According to a fifth aspect, an embodiment of this application provides a computer program product. The computer program product includes computer program code. When the computer program code is run by a communications unit, a processing unit or a transceiver, or a processor of a communications device, the communications device is enabled to perform any method in any one of the first aspect or the possible implementations of the first aspect.

According to a sixth aspect, an embodiment of this application provides a computer-readable storage medium. The computer-readable storage medium stores a program, and the program enables a communications device (for example, a terminal device or a network device) to perform any method in any one of the first aspect or the possible implementations of the first aspect.

According to a seventh aspect, an embodiment of this application provides a computer program. When the computer program is executed on a computer, the computer is enabled to implement any method in any one of the first aspect or the possible implementations of the first aspect.

### BRIEF DESCRIPTION OF DRAWINGS

FIG. 1 is a schematic architectural diagram of a resource lock management system according to this application;

FIG. 2 is a schematic architectural diagram of another resource lock management system according to this application;

FIG. 3 is a schematic diagram of a resource lock management scenario according to this application;

FIG. 4 is a schematic diagram of a first resource lock management method according to this application;

FIG. 5 is a schematic diagram of a first resource lock information division according to this application;

FIG. 6 is a schematic diagram of a second resource lock information division according to this application;

FIG. 7 is a schematic diagram of a third resource lock information division according to this application;

FIG. 8 is a schematic flowchart of performing an exclusive lock addition/release operation on a target resource based on resource lock information according to this application;

FIG. 9 is a schematic diagram of releasing an exclusive lock from a target resource based on resource lock information according to this application;

FIG. 10 is a schematic diagram of directly adding, by a first node, an exclusive lock to a target resource according to this application;

FIG. 11 is a schematic diagram of first resource lock information in a process in which a first node performs exclusive lock addition/release on a target resource according to this application;

FIG. 12 is a schematic diagram in which a first node queues to wait to add an exclusive lock to a target resource according to this application;

FIG. 13 is a schematic diagram of second resource lock information in a process in which a first node performs exclusive lock addition/release on a target resource according to this application;

FIG. 14 is a schematic flowchart of performing a shared lock addition/release operation on a target resource based on resource lock information according to this application;

FIG. 15 is a schematic diagram of releasing a shared lock from a target resource based on resource lock information according to this application;

FIG. 16 is a schematic diagram of directly adding, by a first node, a shared lock to a target resource according to this application;

FIG. 17 is a schematic diagram of first resource lock information in a process in which a first node performs shared lock addition/release on a target resource according to this application;

FIG. 18 is a schematic diagram in which a first node queues to wait to add a shared lock to a target resource according to this application;

FIG. 19 is a schematic diagram of second resource lock information in a process in which a first node performs shared lock addition/release on a target resource according to this application;

FIG. 20 is a schematic diagram of third resource lock information in a process in which a first node performs shared lock addition/release on a target resource according to this application;

FIG. 21 is a schematic diagram of a scenario implemented by a first node based on an RDMA technology according to this application;

FIG. 22 is a first schematic flowchart of starting and stopping a cluster file system based on an RDLM apparatus according to this application;

FIG. 23 is a first schematic flowchart of performing lock addition/release on a cluster file system based on an RDLM apparatus according to this application;

FIG. 24 is a schematic diagram of a hash table between resource lock information and an index node according to this application;

FIG. 25 is a second schematic flowchart of performing lock addition/release on a cluster file system based on an RDLM apparatus according to this application;

FIG. 26 is a schematic diagram of a first resource lock management apparatus according to this application; and

FIG. 27 is a schematic diagram of a second resource lock management apparatus according to this application.

### DESCRIPTION OF EMBODIMENTS

This application provides a resource lock management method and apparatus, to avoid a problem that lock addition starves on a lock addition node when management is performed in a distributed system in a conventional technology. The following describes embodiments of this application with reference to the accompanying drawings.

The following describes some terms in the embodiments of this application for ease of understanding.

(1) Remote direct memory access (remote direct memory access, RDMA) is a direct memory access technology in which data is directly transferred from a memory of a computer to another computer without intervention by operating systems of both computers. This allows for high-throughput and low-latency network communication, and is especially applicable to a large-scale parallel computer cluster.

(2) A distributed file system includes a plurality of nodes. In the distributed file system, a file is stored in some nodes in a distributed manner, and another node may access the node through a network to perform a read/write operation on the file. The distributed file system may also be referred to as a shared storage-type file system.

When the distributed file system includes a relatively large quantity of nodes, the distributed file system may also be referred to as a cluster file system.

The cluster file system may integrate and virtualize storage space resources of nodes in a cluster, and externally provide a file access service. The cluster file system (oracle cluster file system 2, ocfs2) includes two parts: a user-mode tool and a kernel-mode module. The user-mode tool is mainly used to configure a cluster environment, and perform a management operation such as formatting, installing, or uninstalling the file system. The kernel mode processes a specific file input/output (input/output, I/O) operation, and performs a cluster lock function.

(3) Anode (node) is a device in a distributed file system. The node may store a resource, or may access a resource located on another node. Specifically, the node may be a computing node, a server, a host, a computer, or the like.

(4) An RDMA network interface controller (RDMA network interface controller, RNIC) is a network interface controller (a network adapter) based on an RDMA technology, and provides an RDMA bottom-layer communication capability for a node in a distributed file system.

(5) A resource may be specifically various types of files such as a text, a video, a picture, and audio. In the embodiments of this application, the resource and the file represent a same concept, and may be changed.

(6) A resource lock is set to manage a resource in a distributed file system, and improve resource management efficiency and security. Anode may add a resource lock to a resource on the node or another node, to obtain access permission to perform a read operation and a write operation on the resource.

Currently, the resource lock usually includes a shared lock and an exclusive lock.

The shared lock is also referred to as a read lock. After a node adds the shared lock to a resource, the node may view (to be specific, the read operation) the resource but cannot modify or delete the resource. It should be noted that a plurality of nodes in the distributed file system may simultaneously add the shared lock to a same resource. In addition, when the exclusive lock is added to a resource, another node cannot add the shared lock to the resource.

The exclusive lock is also referred to as an exclusive lock or a write lock. After a node adds the exclusive lock to a resource, the node may perform various operations such as viewing, modifying, and deleting the resource. It should be noted that, in the distributed file system, only one node can add the exclusive lock to a resource at one moment. Similarly, when the shared lock is added to a resource, another node cannot add the exclusive lock to the resource.

In conclusion, in the distributed file system, it needs to be ensured that any type of resource lock is not added to a resource, so that a node may add a type of a resource lock to the resource.

In addition, terms “system” and “network” may be used interchangeably in the embodiments of this application. “At least one” means one or more, and “a plurality of” means two or more. “and/or” describes an association relationship of associated objects, and indicates that there may be three relationships. For example, A and/or B may indicate a case in which only A exists, both A and B exist, and only B exists, where A and B may be singular or complex. The character “/” generally indicates an “or” relationship between the associated objects. “At least one item (piece) of the following” or a similar expression thereof refers to any combination of these items, including any combination of a single item (piece) or a plurality of items (pieces). For example, at least one item (piece) of a, b, or c may represent a, b, c, a-b, a-c, b-c, or a-b-c. Herein, a, b, and c may be singular or plural.

Unless otherwise specified, ordinal numbers such as “first” and “second” mentioned in the embodiments of this application are used to distinguish between a plurality of objects, but are not used to limit a sequence, a time sequence, a priority, or an importance degree of the plurality of objects.

In addition, the terms “including” and “having” in the embodiments, claims, and accompanying drawings of this application are not exclusive. For example, a process, method, system, product, or device that includes a series of steps or modules is not limited to listed steps or modules, and may further include steps or modules that are not listed.

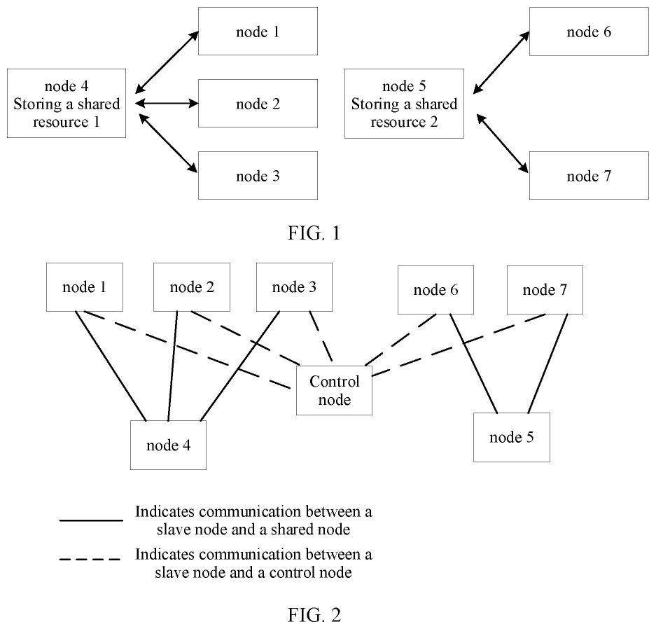

An embodiment of this application provides a distributed file network system to which a resource lock management method may be applied. As shown in FIG. 1, the distributed file system includes a plurality of nodes, for example, a node 01, a node 02, a node 03, a node 4, and the like in the figure.

In the distributed file system, a node may store a shared resource, and another node may access the resource on the node, and adds a resource lock to the shared resource, to obtain access permission to perform a read operation and a write operation on the resource. The node may be referred to as a shared node or a primary node. In this case, the another node that accesses the resource on the node may be referred to as a subnode, a secondary node, or an access node.

For example, the node 4 in FIG. 1 may store a shared resource 1, and the node 1, the node 2, and the node 3 serve as secondary nodes of the node 4, and may access the shared resource 1 on the node 4.

For another example, a node 5 in FIG. 1 stores a shared resource 2, and a node 6 and a node 7 serve as secondary nodes of the node 5, and may access the shared resource 2.

It should be noted that each node in the distributed file system may store a shared resource, or some nodes in the distributed file system store a shared resource, and a quantity of some nodes is not limited.

Optionally, a DLM architecture, an SDLM architecture, or an RDLM architecture may be used for the distributed file system, to implement resource lock management.

In an implementation, the distributed file system may allocate a corresponding shared node to some nodes.

In a first design, the distributed file system includes a control node, and the control node may set a primary-secondary node mapping relationship in the distributed file system. As shown in FIG. 2, the primary-secondary node mapping relationship may be as follows: A node 4 serves as a primary node of a node 1, a node 2, and a node 3, and a node 5 serves as a primary node of a node 6 and a node 7.

Optionally, the primary-secondary node mapping relationship may be represented in Table 1.

TABLE 1
Primary-secondary node mapping relationship

| Secondary node | Primary node |
|---|---|
| node 1 | node 4 |
| node 2 | |
| node 3 | |
| node 6 | node 5 |
| node 7 | |

The control node may send the primary-secondary node mapping relationship to each node (or each secondary node) in the distributed file system; or the control node sends a primary-secondary node mapping relationship including an identifier of each secondary node to a corresponding secondary node. Alternatively, a subnode may obtain the primary-secondary node mapping relationship from the control node when the subnode needs to access a resource of a primary node.

For example, the control node may send the primary-secondary node mapping relationship shown in Table 1 to the node 1 to the node 7, or to the node 1 to the node 3, the node 6, and the node 7. For another example, the control node sends the primary-secondary node mapping relationship node 1<->node 4 to the node 1, sends the primary-secondary node mapping relationship node 2<->node 4 to the node 2, . . . , and sends node 7<->node 5 to the node 7.

According to the design, when a node in the distributed file system needs to access a resource or needs to add a resource lock to a resource, the node may determine, based on the primary-secondary node mapping relationship, a node that stores the resource.

In another design, the distributed file system includes a control node, and the control node may obtain a correspondence between a shared node in the distributed file system and a resource included on the shared node. The correspondence between a shared node and a resource included on the shared node may be as follows: The shared node the node 4 stores the shared resource 1, and the shared node the node5 stores the shared resource 2. Optionally, the correspondence between a shared node and a shared resource may be represented in Table 2.

TABLE 2
Correspondence between a shared node and a shared resource

| Shared node | Shared node |
|---|---|
| node 4 | Shared node 1 |
| node 5 | Shared node 2 |

The control node may send a correspondence between all shared nodes and resources included on the shared nodes to each node (or each secondary node) in the system, or send a correspondence between a specific shared node and a resource included on the specific shared node to a secondary node corresponding to the node. For example, the control node may send the correspondence between a shared node and a shared resource in Table 2 to the node 1 to the node 7, or to the node 1 to the node 3, the node 6, and the node 7. For another example, the control node may send a correspondence between a shared node 4 and a shared resource node 4<->shared resource 1 to the node 1 to the node 3, and send a correspondence between a shared node 5 and a shared resource node 5<->shared resource 2 to the node 6 and the node 7.

According to the design, when a node in the distributed file system needs to access a resource or needs to add a resource lock to a resource, the node may determine, based on the correspondence between a shared node and a resource included on the shared node, a node that stores the resource.

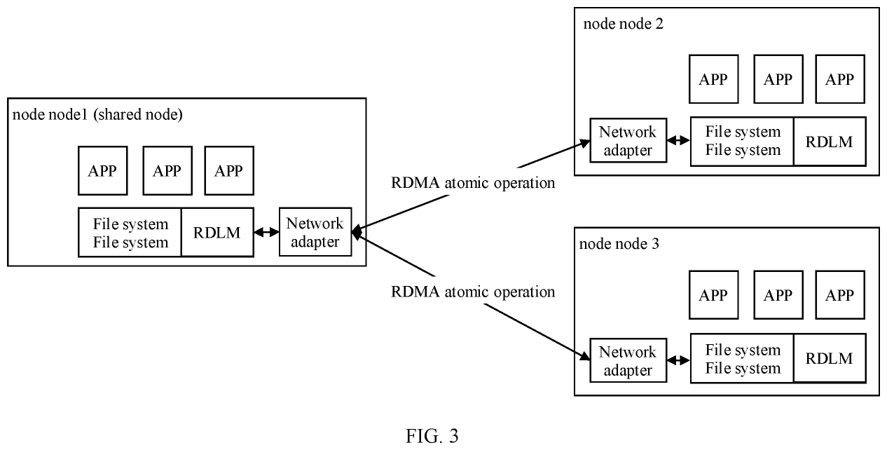

In a possible implementation, communication between nodes in the distributed file system (for example, a node accesses a resource on the shared node) may be implemented based on an RDMA technology. As shown in FIG. 3, when the node 2 or the node 3 needs to perform a resource lock addition/release operation and a read/write operation on the target resource, it is determined that the shared node that stores the target resource is the node 1. Then, the node 2 or the node 3 may separately perform the foregoing operations on the target resource based on the RDMA technology.

A network communication processing capability of a node may be offloaded to a network adapter based on the RDMA technology. Therefore, when the node 2 or the node 3 sends an instruction corresponding to the resource lock addition/release operation and the read/write operation to the node 1, a kernel network protocol stack of the node 1 may be bypassed, to reduce a quantity of times of copying data. A host CPU and an operating system of the node 1 are not required, to greatly improve network transmission performance of the distributed file system.

Currently, in a conventional technology, a method for adding, by a node in a distributed file system, a resource lock to a target resource is usually as follows:

Method 1: A DLM technology of a decentralized architecture is used to perform resource lock addition/release management on the target resource.

Method 2: An SDLM technology of a centralized architecture is used to perform resource lock addition/release management on the target resource.

However, a main problem about performing resource lock addition/release management on the shared resource in the distributed file system is as follows: When the resource lock is added to the shared resource either in Method 1 or Method 2, there is usually a case in which a node infinitely waits to perform lock addition when a plurality of nodes concurrently perform a lock addition operation on the target resource.

For example, it is assumed that the node 1, the node 2, the node 3, and the node 4 concurrently perform a lock addition operation on the target resource. It is assumed that the node 2 requests to perform the lock addition operation on the target resource earlier than another node, but the node 1, the node 3, and the node 4 all successfully complete the lock addition operation on the target resource, and the node 2 always fails to successfully perform the lock addition operation on the target resource. Therefore, the node 2 infinitely waits to perform lock addition, causing a phenomenon that lock addition starves.

To resolve this problem, an embodiment of this application provides a resource lock management method. The method may be applied to the distributed file system shown in FIG. 1. In the system, the node that stores the shared resource maintains one piece of resource lock information for each shared resource, so that another node in the system performs lock management on the shared resource.

For ease of description of this embodiment of this application, in the following embodiment, a node that needs to perform a resource lock addition/release operation is referred to as a first node.

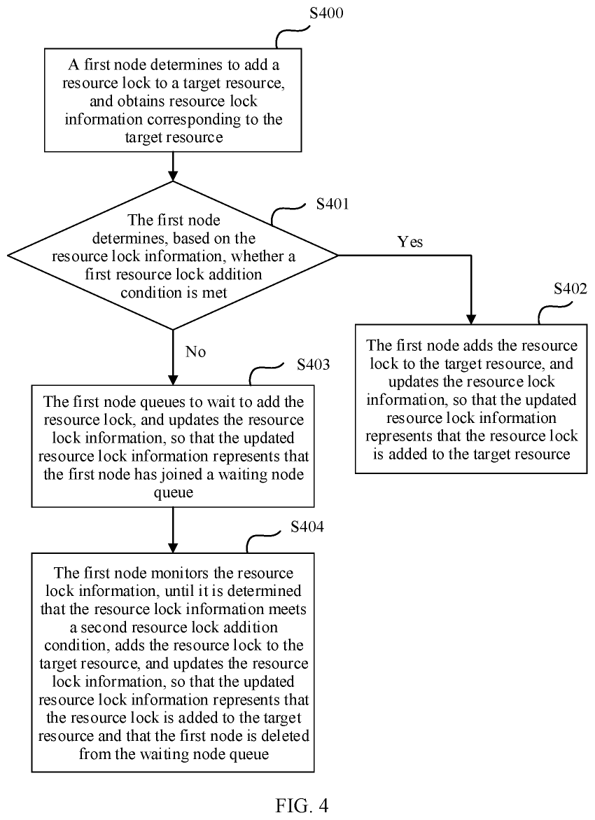

As shown in FIG. 4, the method specifically includes the following process.

S400: A first node determines to add a resource lock to a target resource, and obtains resource lock information corresponding to the target resource.

The resource lock information is used to represent whether the resource lock is added to the target resource, and information about a waiting node queue that requests to add the resource lock. A type of the resource lock is an exclusive lock or a shared lock.

Based on different specific scenarios, the first node may obtain the resource lock information in the following manners:

Scenario 1: When the target resource is located on the first node, the first node locally obtains, from the first node, the resource lock information corresponding to the target resource.

Scenario 2: When the target resource is located on another node (which may be referred to as a second node subsequently for ease of description), the first node obtains, from the second node, the resource lock information corresponding to the target resource.

In Scenario 2, before the first node obtains, from the second node, the resource lock information corresponding to the target resource, the first node needs to determine the second node that stores the target resource.

Optionally, a manner in which the first node determines the second node may include but not limited to:

Determining manner 1: The first node determines the second node based on a primary-secondary node mapping relationship sent by the control node.

For example, it is assumed that the first node is a node 2. The primary-secondary node mapping relationship that is received by the first node and that is sent by the control node is shown in Table 1. When the first node needs to access a resource or needs to add a resource lock to a resource, it may be determined, based on Table 1, that a primary node corresponding to the first node is a node 4. Therefore, the first node determines the node 4 as the second node.

Determining manner 2: The first node determines, based on a correspondence that is sent by the control node and that is between all shared nodes and resources included on the shared nodes, a shared node corresponding to the target resource, and determines the shared node corresponding to the target resource as the second node.

For example, it is assumed that the first node is a node 2, the target resource on which the first node requests to perform an addition/release operation is a shared resource 1, and a correspondence that is received by the first node, that is sent by the control node, and that is between all shared nodes and resources included on the shared nodes is shown in Table 2. The first node may determine, based on Table 2, that the shared node corresponding to the target resource is a node 4. Therefore, the first node determines the node 4 as the second node.

S401: The first node determines, based on the resource lock information, whether a first resource lock addition condition is met, and performs step S402 if the first resource lock addition condition is met, or performs step S403 if the first resource lock addition condition is not met.

S402: The first node adds the resource lock to the target resource, and updates the resource lock information, so that the updated resource lock information represents that the resource lock is added to the target resource.

S403: The first node queues to wait to add the resource lock, and updates the resource lock information, so that the updated resource lock information represents that the first node has joined the waiting node queue, to continue to perform step S404.

S404: The first node monitors the resource lock information, until it is determined that the resource lock information meets a second resource lock addition condition, adds the resource lock to the target resource, and updates the resource lock information, so that the updated resource lock information represents that the resource lock is added to the target resource and that the first node is deleted from the waiting node queue.

According to the foregoing method, when adding the resource lock to the target resource, the first node may perform a lock addition operation based on the resource lock information corresponding to the target resource. The first node may determine, based on the resource lock information, whether an exclusive resource lock is currently added to the target resource and information about a node queue that requests to add the resource lock, to effectively improve a problem that lock addition starves on a lock addition node when management is performed in a distributed system.

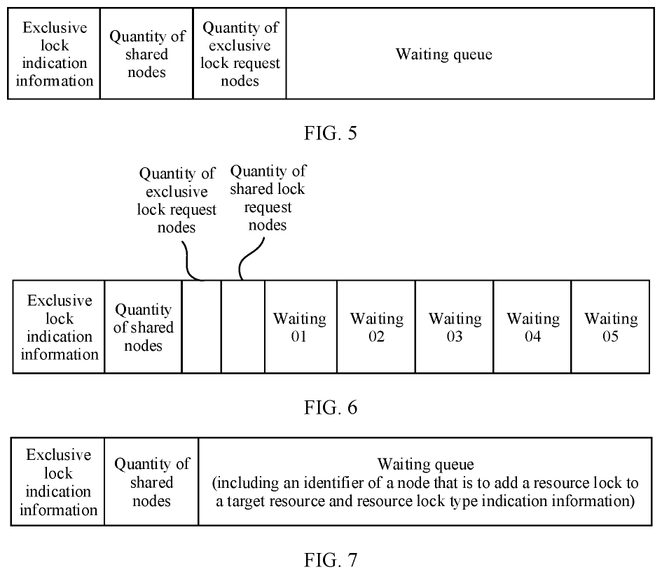

Optionally, in an embodiment, as shown in FIG. 5, the resource lock information includes exclusive lock indication information, a waiting node queue, a quantity of shared nodes, and a quantity of exclusive lock request nodes.

The exclusive lock indication information is used to indicate whether an exclusive lock is added to the target resource; the quantity of shared nodes is a quantity of nodes that have added a shared lock to the target resource; the waiting node queue is a queue including an identifier of a node that requests to add the resource lock to the target resource, and the identifier of the node in the waiting node queue is arranged in a sequence of requesting to add the resource lock; and the quantity of exclusive lock request nodes is a quantity of nodes that request to add the exclusive lock in the waiting node queue. Optionally, in another embodiment, as shown in FIG. 6, the resource lock information further includes a quantity of shared lock request nodes. The quantity of shared lock request nodes is a quantity of nodes that request to add the exclusive lock in the waiting node queue.

According to the foregoing method, the resource lock information is divided into the exclusive lock indication information, the waiting node queue, the quantity of shared nodes, the quantity of exclusive lock request nodes, and the quantity of shared lock request nodes, so that when the first node performs a resource lock addition operation on the target resource, the first node may determine, based on the resource lock information, whether the exclusive lock or the shared lock is currently added to the target resource, whether there is a node that waits to add a resource lock to the target resource, and a quantity of corresponding nodes.

Optionally, in an embodiment, the resource lock information is shown in FIG. 7, and the waiting node queue further includes resource lock type indication information of each node. Resource lock type indication information of any node is used to indicate a type of a resource lock that the node requests to add. In this case, the first node may determine, based on the waiting node queue, a quantity of nodes that wait to add the shared lock to the target resource and a quantity of nodes that have added the exclusive lock. Therefore, the resource lock information may not need to divide the quantity of exclusive lock request nodes and the quantity of shared lock request nodes.

In addition, in an embodiment, in the distributed file system, the quantity of shared nodes in the resource lock information may be further set to a threshold n. In other words, the target resource supports a maximum of n nodes in adding the shared lock to the target resource at one moment. When a node needs to add the shared lock to the target resource, and determines that the quantity of shared nodes in the resource lock information is n, the node needs to queue to wait.

The following specifically describes S401 to S404 based on a type of a resource lock that the first node requests to add, and a resource lock information division manner shown in FIG. 6 is selected for detailed descriptions.

Resource lock type 1: The first node performs an exclusive lock addition/release operation on the target resource.

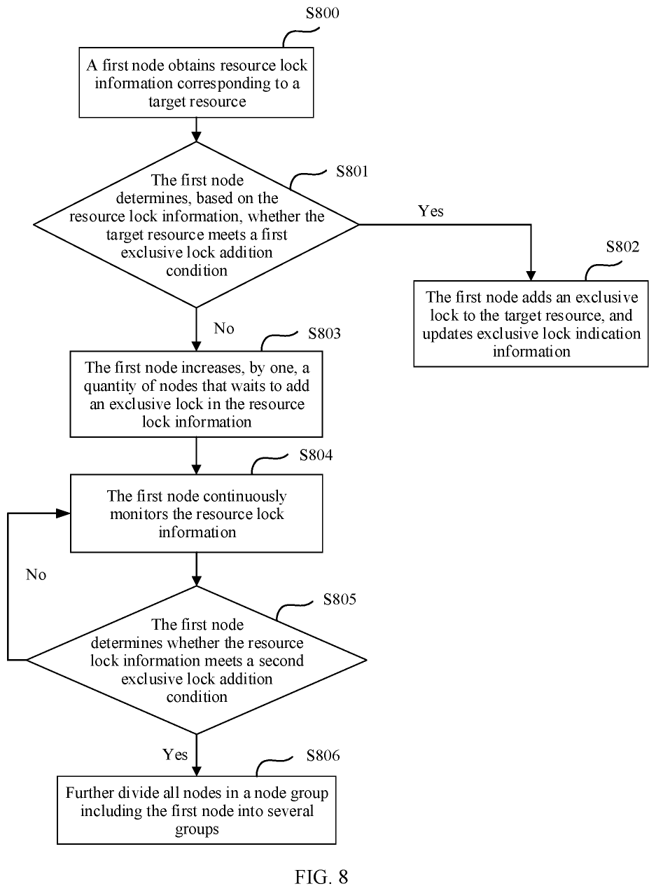

As shown in FIG. 8, this application provides a process of adding the exclusive lock to the target resource, including the following steps.

S800: The first node obtains the resource lock information corresponding to the target resource.

S801: The first node determines, based on the resource lock information, whether the target resource meets a first exclusive lock addition condition, and performs S802 if the target resource meets the first exclusive lock addition condition, or performs S803 if the target resource does not meet the first exclusive lock addition condition.

According to an exclusive lock addition rule in the foregoing description of the exclusive lock, in this embodiment of this application, the first exclusive lock addition condition is as follows: The exclusive lock indication information indicates that no exclusive lock is added to the target resource, the quantity of shared nodes is 0, and a quantity of nodes in the waiting node queue is 0.

S802: The first node adds the exclusive lock to the target resource, and updates the exclusive lock indication information.

In this application, the updated exclusive lock indication information indicates that the first node currently has added the exclusive lock to the target file resource.

S803: The first node increases the quantity of exclusive lock request nodes in the resource lock information by one.

S804: The first node continuously monitors the resource lock information.

S805: The first node determines whether the resource lock information meets a second exclusive lock addition condition, and performs S806 if the resource lock information meets the second exclusive lock addition condition, or performs S804 if the resource lock information does not meet the second exclusive lock addition condition.

In this application, the second exclusive lock addition condition is as follows: The exclusive lock indication information indicates that no exclusive lock is added to the target resource, the quantity of shared nodes is 0, and an identifier of the first node is located at a start position in the waiting node queue.

S806: The first node adds the exclusive lock to the target resource, updates the lock indication information, and decreases the quantity of exclusive lock request nodes by one.

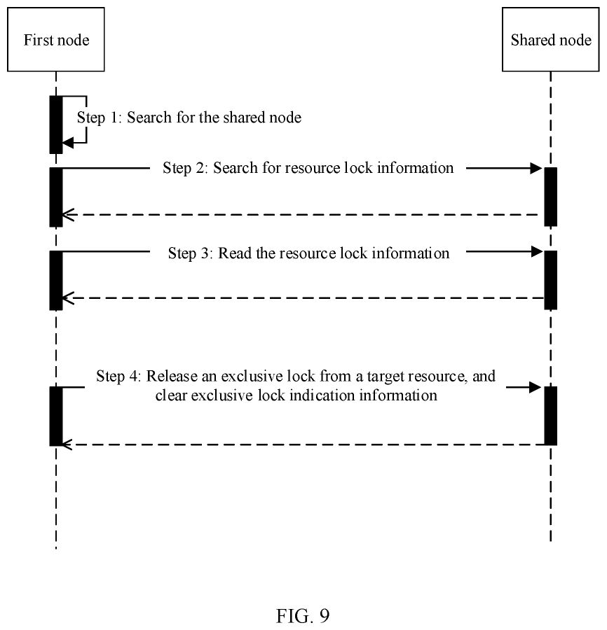

Optionally, in this application, after adding the exclusive lock to the target resource, the first node further performs an exclusive lock release operation on the target resource when a specific condition is met. As shown in FIG. 9, when the first node needs to release the exclusive lock added to the target resource, the first node determines a shared node that stores the target resource. The first node searches for the resource lock information corresponding to the target resource, and then reads the resource lock information. The first node releases the exclusive lock from the target resource, and clears information that is about the first node and that is recorded in the exclusive lock indication information.

In the foregoing method, when performing an exclusive lock addition operation on the target resource, the first node may determine, based on the resource lock information corresponding to the target resource, whether the first exclusive lock addition condition is currently met, and directly perform the lock addition operation if the first exclusive lock addition condition is met; or if the first exclusive lock addition condition is not met, queue to wait to perform the exclusive lock addition operation in the sequence of requesting to add the resource lock to the target resource. In a process of queuing to wait, if determining that the second exclusive lock addition condition is met, the first node performs the exclusive lock addition operation on the target resource. It is clear that, according to the method, a case in which the first node that requests to add the exclusive clock in the waiting node queue is continuously stopped through a queue jump and preemption and cannot successfully perform lock addition for a long time can be effectively avoided, and a problem that lock addition starves on the first node can be resolved.

Based on the foregoing embodiments, this application further provides an example in which the exclusive lock addition/release operation is performed on the target resource. The example is described below.

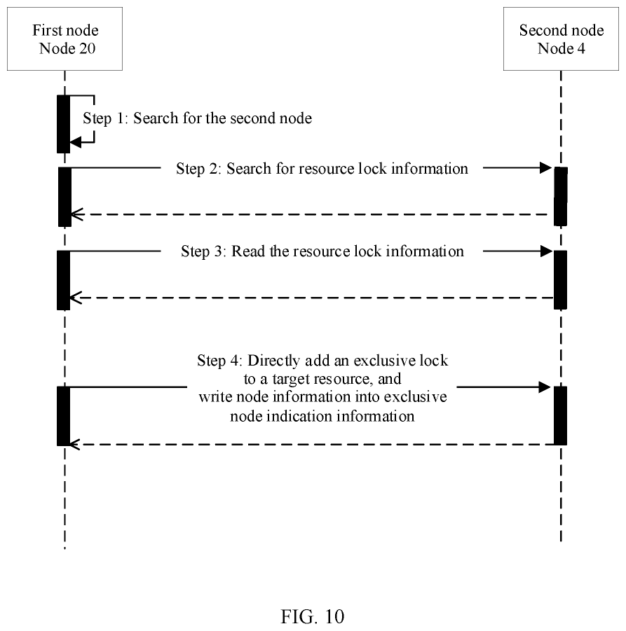

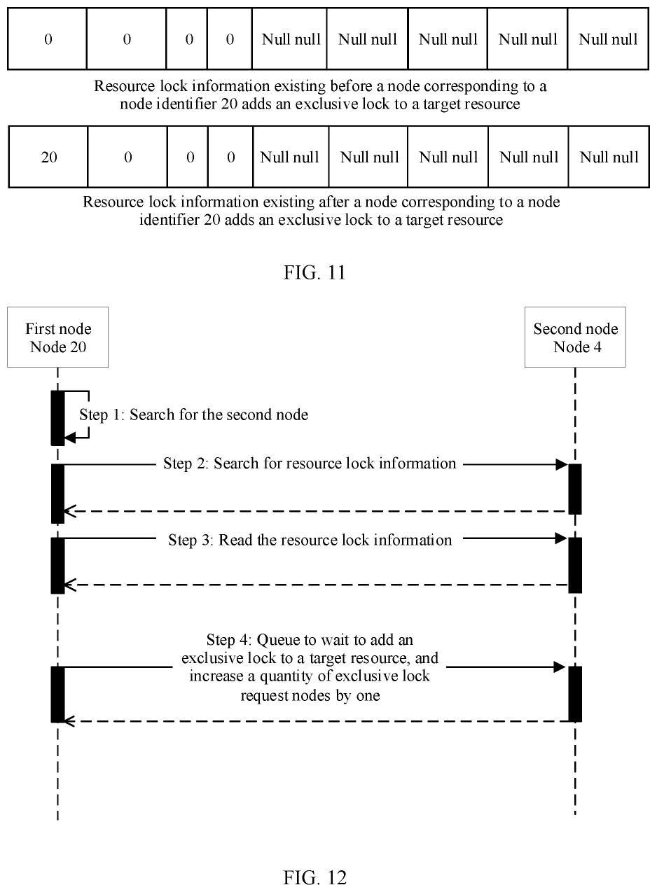

Example 1: As shown in FIG. 10, it is assumed that the first node is a node 20, the first node determines, based on the primary-secondary node mapping relationship, that the second node is the node 4, and the resource lock information that corresponds to the target resource and that is obtained by the first node from the second node is shown in FIG. 11.

It may be determined from FIG. 11 that the target resource currently meets the first exclusive lock addition condition. Therefore, the first node adds the exclusive lock to the target resource, adds node information of the first node to the exclusive lock indication information, and finally updates the resource lock information.

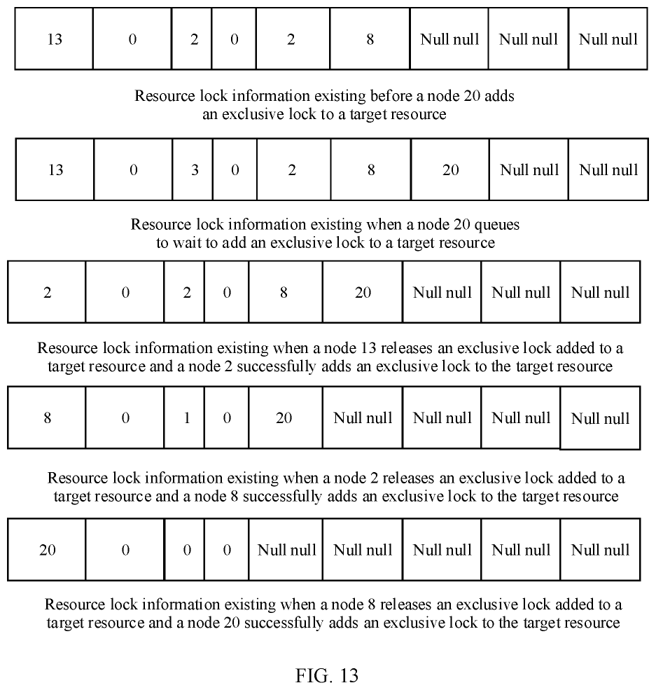

Example 2: As shown in FIG. 12, it is assumed that the first node is a node 20, the first node determines, based on the primary-secondary node mapping relationship, that the second node is the node 4, and the resource lock information that corresponds to the target resource and that is obtained by the first node from the second node is shown in FIG. 13. It may be determined from FIG. 12 that the target resource currently does not meet the first exclusive lock addition condition. Therefore, if the first node needs to queue to wait to add the exclusive lock to the target resource, the first node sequentially records the node information in the waiting node queue in the resource lock information, and increases the quantity of exclusive lock request nodes in the resource lock information by one.

The first node continuously monitors the resource lock information. After a node 13 releases the exclusive lock added to the target resource, the node 2 located in the waiting node queue sequentially adds the exclusive lock to the target resource, adds node information of the node 2 to the exclusive lock indication information, and decreases the quantity of exclusive lock request nodes by one.

After the node 2 releases the exclusive lock added to the target resource, a node 8 located in the waiting node queue sequentially adds the exclusive lock to the target resource, adds node information of the node 8 to the exclusive lock indication information, and decreases the quantity of exclusive lock request nodes by one.

The first node continues to monitor the resource lock information, until the node 8 releases the exclusive lock added to the target resource, and the node information of the first node is located at the start position in the waiting node queue. In this case, the first node determines, based on the resource lock information, that the target resource currently meets the second exclusive lock addition condition.

Therefore, the first node adds the exclusive lock to the target resource, adds the node information of the first node to the exclusive lock indication information, decreases the quantity of exclusive lock request nodes by one, and finally updates the resource lock information.

Resource lock type 2: The first node performs a shared lock addition/release operation on the target resource.

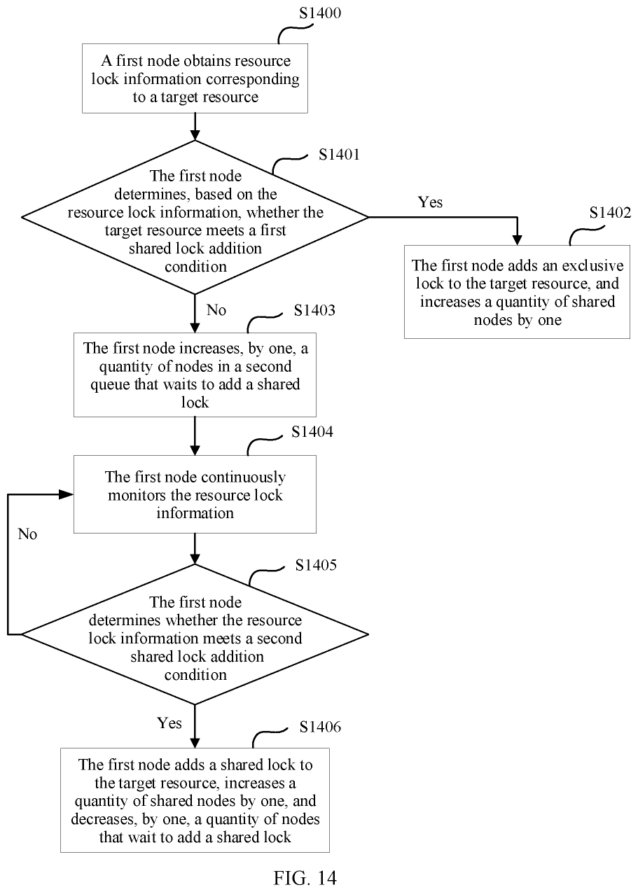

As shown in FIG. 14, this application provides a process of adding the shared lock to the target resource, including the following steps.

S1400: The first node obtains the resource lock information corresponding to the target resource.

S1401: The first node determines, based on the resource lock information, whether the target resource meets a first shared lock addition condition, and performs S1402 if the target resource meets the first shared lock addition condition, or performs S1403 if the target resource does not meet the first shared lock addition condition.

In this application, the first shared lock addition condition is as follows: The exclusive lock indication information indicates that no exclusive lock is added to the target file resource, and a quantity of nodes in a first queue that waits to add the exclusive lock is 0.

S1402: The first node adds the exclusive lock to the target resource, and increases the quantity of shared nodes by one.

S1403: The first node increases, by one, a quantity of nodes in a second queue that waits to add the shared lock.

S1404: The first node continuously monitors the resource lock information.

S1405: The first node determines whether the resource lock information meets a second shared lock addition condition, and performs S1406 if the resource lock information meets the second shared lock addition condition, or performs S1404 if the resource lock information does not meet the second shared lock addition condition.

In this application, the second shared lock addition condition is as follows: The exclusive lock indication information indicates that no exclusive lock is added to the target resource, and an identifier of the first node is located at a start position in the first waiting node queue.

S1406: The first node adds the shared lock to the target resource, increases the quantity of shared nodes by one, and decreases the quantity of shared lock request nodes by one.

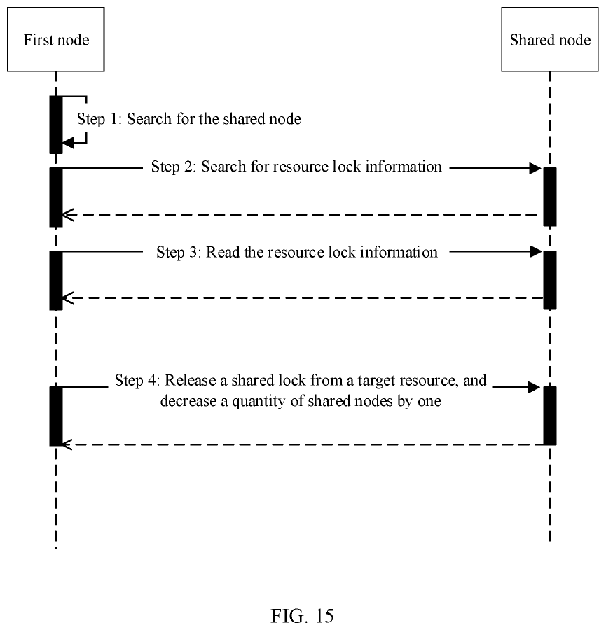

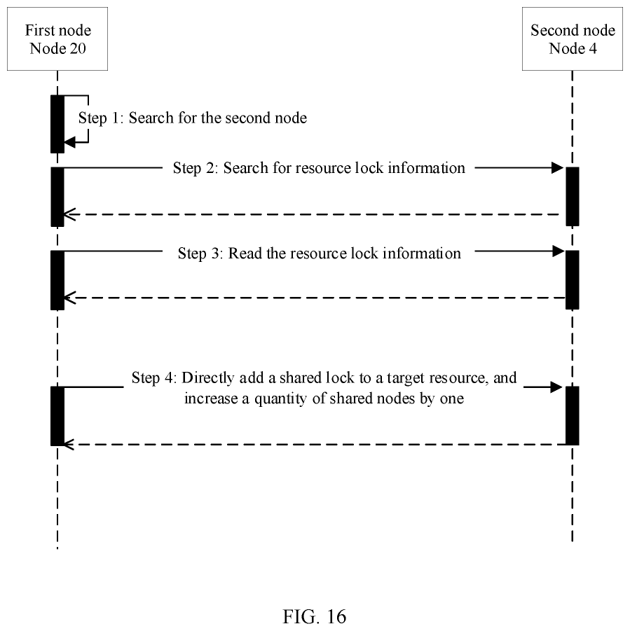

Optionally, in this application, after adding the shared lock to the target resource, the first node further performs a shared lock release operation on the target resource when a specific condition is met. As shown in FIG. 15, when the first node needs to release the shared lock added to the target resource, the first node determines a shared node that stores the target resource. The first node searches for the resource lock information corresponding to the target resource, and then reads the resource lock information. The first node releases the shared lock from the target resource, and decreases the quantity of shared nodes by one.

In the foregoing method, when performing a shared lock addition operation on the target resource, the first node may determine, based on the resource lock information corresponding to the target resource, whether the first shared lock addition condition is currently met, and directly perform the lock addition operation if the first shared lock addition condition is met; or if the first shared lock addition condition is not met, queue to wait to perform the shared lock addition operation in the sequence of requesting to add the resource lock to the target resource. In a process of queuing to wait, if determining that the second shared lock addition condition is met, the first node performs the shared lock addition operation on the target resource. It is clear that, according to the method, a case in which the first node that requests to add the shared clock in a waiting queue is continuously stopped through a queue jump and preemption and cannot successfully perform lock addition for a long time can be effectively avoided, and a problem that lock addition starves on the first node can be resolved.

Based on the foregoing embodiments, this application further provides an example in which the shared lock addition/release operation is performed on the target resource. The example is described below.

Example 1: As shown in FIG. 16, it is assumed that the first node is a node 20, the first node determines, based on the primary-secondary node mapping relationship, that the second node is the node 4, and the resource lock information that corresponds to the target resource and that is obtained by the first node from the second node is shown in FIG. 17.

It may be determined from FIG. 17 that the target resource currently meets the first shared lock addition condition. Therefore, the first node adds the shared lock to the target resource, increases the quantity of shared nodes in the resource lock information by one, and finally updates the resource lock information.

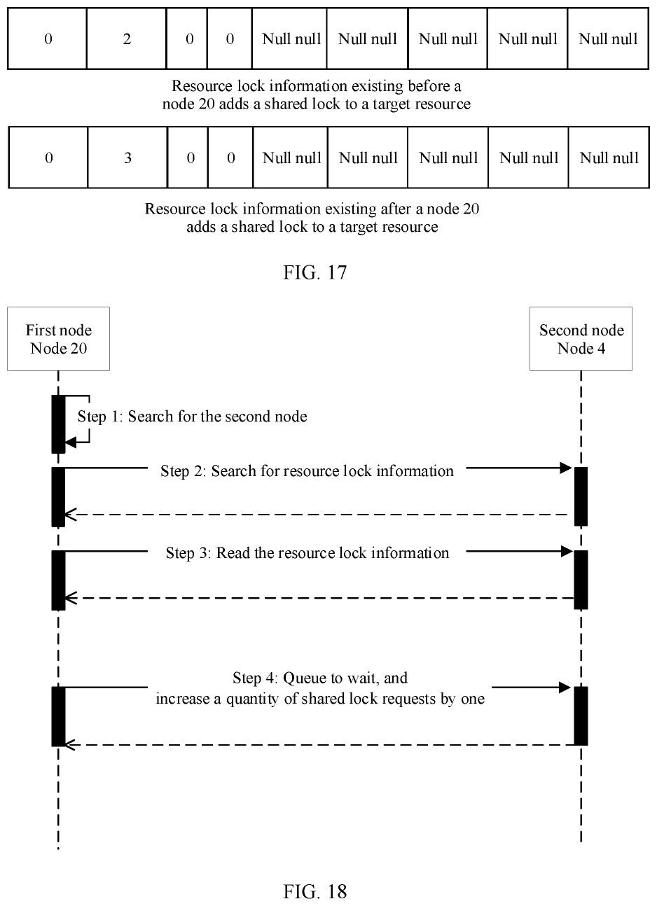

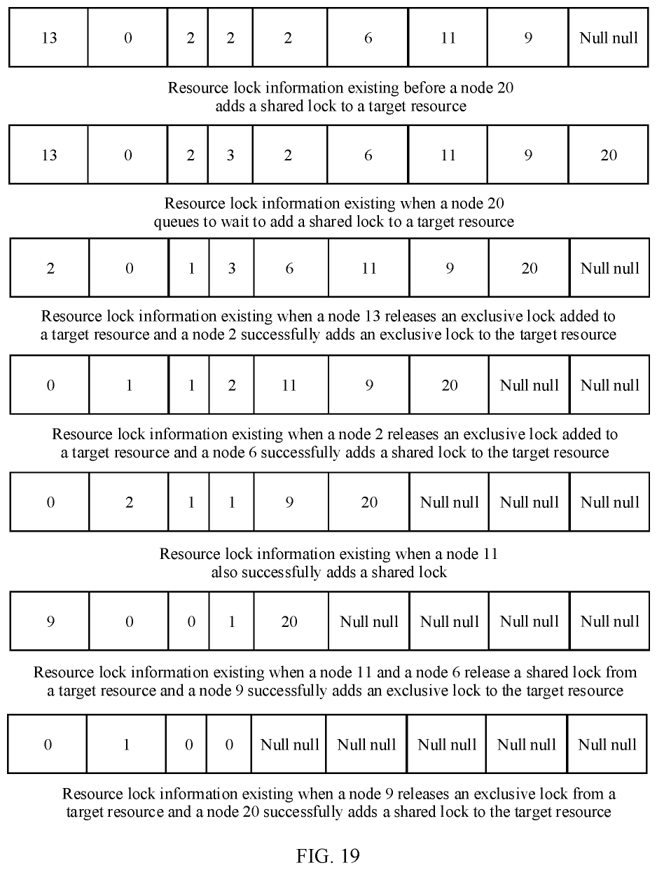

Example 2: As shown in FIG. 18, it is assumed that the first node is a node 20, the first node determines, based on the primary-secondary node mapping relationship, that the second node is the node 4, and the resource lock information that corresponds to the target resource and that is obtained by the first node from the second node is shown in FIG. 19. It may be determined from FIG. 19 that the target resource currently does not meet the first shared lock addition condition. Therefore, if the first node needs to queue to wait to add the shared lock, the first node sequentially records the node information in the waiting node queue in the resource lock information, and increases the quantity of shared lock request nodes in the resource lock information by one.

In Example 2, it is assumed that identifiers of nodes that queue to wait in the waiting node queue are sequentially the node 2 that needs to add the exclusive lock to the target resource, a node 6 that needs to add the shared lock to the target resource, a node 11 that needs to add the shared lock to the target resource, and a node 9 that needs to add the exclusive lock to the target resource. The first node continuously monitors the resource lock information. After a node 13 releases the exclusive lock added to the target resource, the node 2 located in the waiting node queue sequentially adds the exclusive lock to the target resource, adds node information of the node 2 to the exclusive lock indication information, and decreases the quantity of exclusive lock request nodes by one.

After the node 2 releases the exclusive lock added to the target resource, the node 6 located in the waiting node queue sequentially adds the shared lock to the target resource, increases the quantity of shared nodes by one, and decreases the quantity of shared lock request nodes by one.

Optionally, the shared lock is currently added to the target resource, and a plurality of shared locks may be simultaneously added to the target resource. Therefore, the node 11 located in the waiting node queue may also add the shared lock to the target resource, increase the quantity of shared nodes by one, and decrease the quantity of shared lock request nodes by one.

After the node 11 and the node 6 both release the shared lock added to the target resource, the node 9 located at the start position in the waiting node queue sequentially adds the exclusive lock to the target resource, adds node information of the node 9 to the exclusive lock indication information, and decreases the quantity of exclusive lock request nodes by one.

The first node continues to monitor the resource lock information, until the node 9 releases the exclusive lock added to the target resource, and the node information of the first node is located at the start position in the waiting node queue. In this case, the first node determines, based on the resource lock information, that the target resource currently meets the second shared lock addition condition.

Therefore, the first node adds the shared lock to the target resource, increases the quantity of shared nodes by one, decreases the quantity of shared lock request nodes by one, and finally updates the resource lock information.

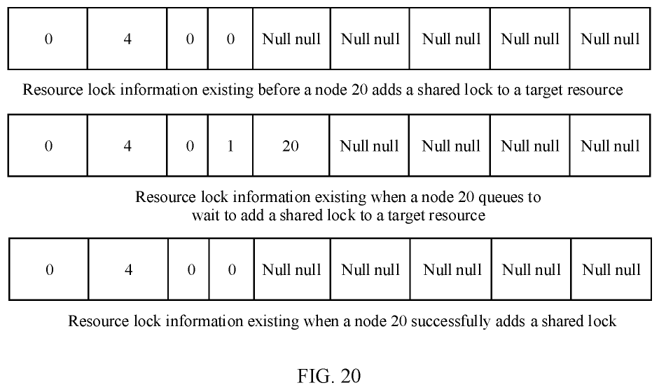

Example 3: The first node is a node 20. The resource lock information corresponding to the target resource is shown in FIG. 20. It is assumed that each shared resource in the distributed file system supports a maximum of four nodes in adding the shared lock at one moment.

It may be determined from FIG. 20 that the target resource meets the first shared lock addition condition, but the target resource currently reaches a threshold 4 for adding the shared lock. Therefore, if the first node needs to queue to wait to add the shared lock to the target resource, the first node sequentially records the node information in the waiting node queue in the resource lock information, and increases the quantity of shared lock request nodes in the resource lock information by one.

The first node continues to monitor the resource lock information, until a quantity of nodes that currently have added the shared lock to the target resource is less than 4, and the node information of the first node is located at the start position in the waiting node queue. In this case, the first node adds the shared lock to the target resource, increases the quantity of shared nodes by one, decreases the quantity of shared lock request nodes by one, and finally updates the resource lock information.

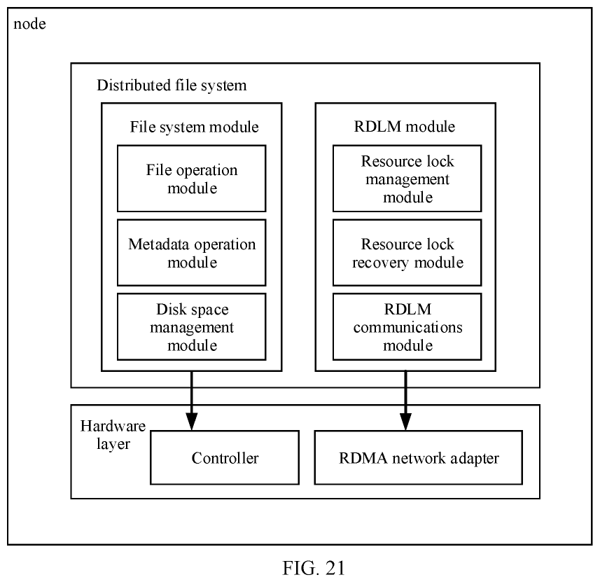

Optionally, as shown in FIG. 21, based on an advantage of an RDMA technology in this application, a distributed lock manager RDLM based on the RDMA technology is introduced in a resource lock management process in the distributed file system. A file system module shown in FIG. 21 is configured to provide a file management service for an upper-layer application, including a file read/write operation, a file modification operation, a file deletion operation, and the like.

The file operation module is configured to register a common file operation function with a virtual machine file system (VFS), to provide a file read/write operation, a file modification operation, a file deletion operation, and the like for the upper-layer application. The metadata operation module mainly manages attribute information of a file, for example, a file size, permission, a modification time, and a position in a disk. The disk space management module mainly manages storage space of the file system, for example, allocates disk space and recycles disk space.

The RDLM module is configured to provide a distributed lock service for the upper-layer application, to ensure that cluster nodes concurrently access a shared file resource. The resource lock management module manages resource lock information by using a hash table (hash table) data structure. The resource lock recovery module is responsible for recovering the resource lock information. The RDMA communications module is responsible for initializing remote virtual memory space, and is configured to perform resource lock data interaction with a remote computing node.

Therefore, in this application, the resource lock information corresponding to the target resource may be stored on a node of the distributed file system based on the RDMA technology. It is clear that, according to this method, a problem in a conventional technology that system overheads may be excessively large and system deadlock occurs in a process in which when the first node performs lock addition/release on the target resource, the first node needs to obtain the resource lock information by using a third-party storage server may be effectively reduced.

There are a plurality of manners of performing resource lock management based on the RDLM apparatus in this application. The following lists several processes of starting resource lock management by using the RDLM and processes of performing, by the first node, lock addition/release in the distributed network system.

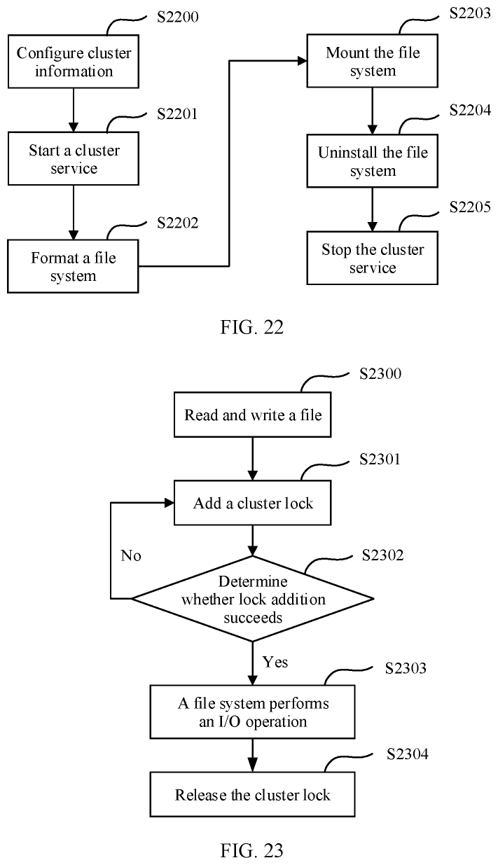

In an embodiment of this application, as shown in FIG. 22, a process of starting and stopping an open-source ocfs2 cluster file system is as follows:

S2200: Configure cluster information.

Specifically, a cluster configuration file is created on all hosts in a cluster, and node information is added, and includes a name, an IP address, and the like of a node.

S2201: Start a cluster service.

Specifically, cluster configuration information is transferred to a kernel mode by using a user-mode tool, and an RDMA network listening process is started in the kernel mode.

S2202: Format the file system.

Specifically, metadata information of the file system is initialized and written into a disk area.

S2203: Install the file system.

Specifically, an RDLM module is initialized, and establishes a mutual trust connection with an RDLM of another computing node. Then, a file operation function of the ocfs2 is registered with a virtual file system (virtual file system, VFS), so that an upper-layer application may invoke an operation file by using the system.

S2204: Uninstall the file system.

Specifically, dirty memory data of the file system is synchronized to a disk, all cluster locks are released, RDLM connections to all nodes are broken, the RDLM module is uninstalled, and finally a file system module is uninstalled.

S2205: Stop a cluster service.

Specifically, an RDMA network connection is broken, an RDMA network communication process is stopped, and finally cluster configuration information is cleared.

This application further provides an embodiment of a resource lock management method. As shown in FIG. 23, a process in which a cluster node of an open-source ocfs2 cluster file system performs lock addition/release is as follows:

S2300: Read and write a file.

Specifically, a user-mode application invokes a read/write (read/write) system call interface by using glibc (glibc), and then triggers a file read/write function registered by the ocfs2 at a VFS layer in the kernel mode.

S2301: Add a cluster lock.

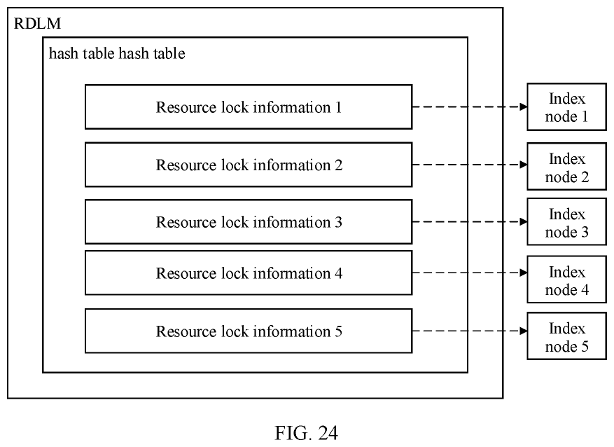

Specifically, a file index node number is obtained, a hash (hash) operation rule 1 is performed on the index node number, to generate a node number of a second node corresponding to resource lock information, and then a hash operation rule 2 is performed on the index node number, to find a specific position of the resource lock information in a hash table. The hash table is shown in FIG. 24. The resource lock information is read, and whether lock addition can be performed based on a current state of a resource lock. A value of the resource lock information in the hash table is modified by using a compare and swap (compare and swap)/fetch and add (fetch and add) command provided by an RDMA, to complete an exclusive lock addition operation/a shared lock addition operation.

S2302: Determine whether lock addition succeeds.

If it is determined that lock addition fails, lock addition is retried.

Specifically, if a failure is returned in the compare and swap/fetch and add command, it indicates that the resource lock is added by another node. In this case, the node tries to join a lock queue and queues to wait to perform lock addition. If it is found that the second node is broken down, a lock addition request is redirected to a new second node to complete lock addition.

S2303: The file system performs an I/O operation.

Specifically, memory and disk space are allocated for this I/O operation, user data forms an input/output (block input output, bio) structure of a block device, a bio request is delivered to a physical address of a corresponding block device, and an I/O result waits to be returned.

S2304: Release a cluster lock.

Specifically, after the I/O result is returned, the value of the resource lock information in the hash table is modified by using the compare and swap/fetch and add command provided by the RDMA, to release the exclusive lock/shared lock. Then, the I/O ends.

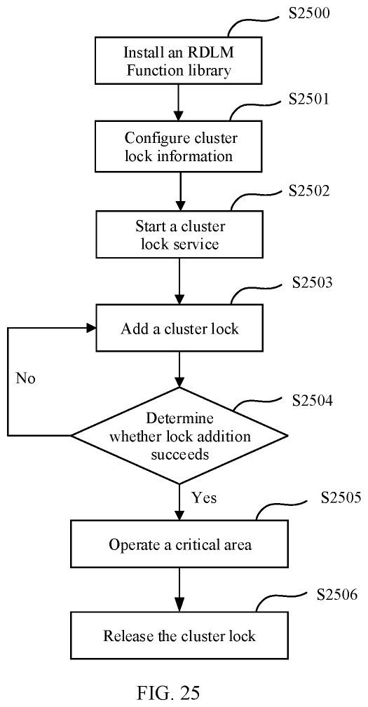

In an embodiment of this application, a user-mode distributed lock solution is used as an example to describe an RDLM lock addition/release process. A specific process is shown in FIG. 25.

S2500: Install an RDLM function library.

Specifically, the RDLM function library and an interface header file are installed on all hosts in a cluster. After the application includes the header file, an RDLM lock addition/release interface can be invoked.

S2501: Configure cluster lock information.

Specifically, a cluster configuration file is created on all the hosts in the cluster, a host name and an IP address are added, and a first node and a second node are planned.

S2502: Start a cluster lock service.

Specifically, the cluster lock service is started on the first node, a connection to the remote second node is listened, and then memory space is allocated to a resource lock hash table, and the memory space is registered with RDMA for remote data exchange.

S2503: Add a cluster lock.

Specifically, a universally unique identifier (universally unique identifier, UUID) is calculated based on content or a feature of a critical area that needs to be protected, a hash operation rule 1 is performed on the UUID, to generate a corresponding number of the second node, and a hash operation rule 2 is performed on the UUID, to find a specific position of the resource lock information in the hash table. Resource lock information is read, and whether lock addition can be performed is determined based on a current state of the resource lock. A value of the resource lock information in the hash table is modified by using a compare and swap/fetch and add command provided by an RDMA, to complete an exclusive lock addition operation/a shared lock addition operation.

S2504: Determine whether lock addition succeeds.

If it is determined that lock addition fails, lock addition is retried.

Specifically, if a failure is returned in the compare and swap/fetch and add command, it indicates that the resource lock is added by another node. In this case, the node tries to join a lock queue and queues to wait to perform lock addition. If it is found that the first node is broken down, a lock request is redirected to a new first node to complete lock addition.

S2505: Operate the critical area.

Specifically, after lock addition succeeds, it indicates that the critical area enters a protection state, and the application may access an operation.

S2506: Release a cluster lock.

Specifically, after the operation on the critical area is completed, the value of the resource lock information in the hash table is modified by using the compare and swap/fetch and add command provided by the RDMA, to release the exclusive lock/shared lock.

Based on the foregoing description of the solutions in this application, it may be understood that, to implement the foregoing functions, the foregoing devices include corresponding hardware structures and/or software modules for executing the functions. A person of ordinary skill in the art should easily be aware that, in combination with units and algorithm steps of the examples described in the embodiments disclosed in this specification, this application may be implemented by hardware or a combination of hardware and computer software. Whether a function is performed by hardware or hardware driven by computer software depends on particular applications and design constraints of the technical solutions. A person skilled in the art may use different methods to implement the described functions for each particular application, but it should not be considered that the implementation goes beyond the scope of this application.

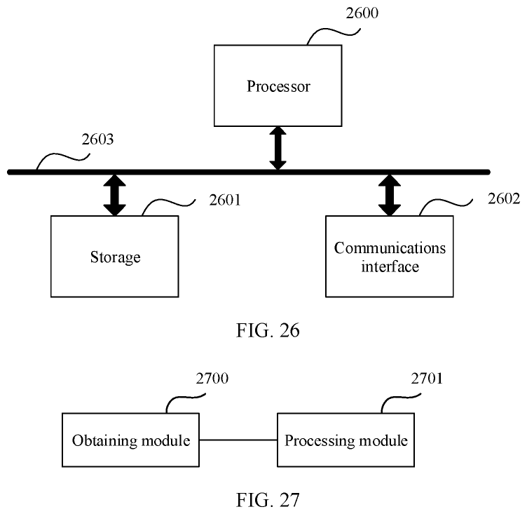

As shown in FIG. 26, this application provides a resource lock management apparatus. The apparatus includes a processor 2600, a storage 2601, and a communications interface 2602.

The processor 2600 is responsible for bus architecture management and general processing. The storage 2601 may store data used when the processor 2600 performs an operation. The communications interface 2602 is configured to perform data communication between the processor 2600 and the storage 2601.

The processor 2600 may be a central processing unit (central processing unit, CPU), a network processor (network processor, NP), or a combination of a CPU and an NP. The processor 2600 may further include a hardware chip. The hardware chip may be an application-specific integrated circuit (application-specific integrated circuit, ASIC), a programmable logic device (programmable logic device, PLD), or a combination thereof. The PLD may be a complex programmable logic device (complex programmable logic device, CPLD), a field-programmable gate array (field-programmable gate array, FPGA), generic array logic (generic array logic, GAL), or any combination thereof. The storage 2601 includes: any medium that can store program code, such as a USB flash drive, a removable hard disk, a read-only memory (read-only memory, ROM), a random access memory (random access memory, RAM), a magnetic disk, or an optical disc.

The processor 2600, the storage 2601, and the communications interface 2602 are connected to each other. Optionally, the processor 2600, the storage 2601, and the communications interface 2602 are connected to each other through a bus 2603. The bus 2603 may be a peripheral component interconnect (peripheral component interconnect, PCI) bus, an extended industry standard architecture (extended industry standard architecture, EISA) bus, or the like. The bus may be classified into an address bus, a data bus, a control bus, and the like. For ease of representation, only one thick line is used to represent the bus in FIG. 26, but this does not mean that there is only one bus or only one type of bus.

Specifically, the processor 2600 is configured to: read a program in the storage 2601, and perform the following operations:

The processor 2600 is configured to: determine to add a resource lock to a target resource, and obtain resource lock information corresponding to the target resource, where the resource lock information is used to represent whether the resource lock is added to the target resource, and information about a waiting node queue that requests to add the resource lock, and a type of the resource lock is an exclusive lock or a shared lock; determine, based on the resource lock information, whether a first resource lock addition condition is met; and if the first resource lock addition condition is met, add the resource lock to the target resource, and update the resource lock information, so that the updated resource lock information represents that the resource lock is added to the target resource; or if the first resource lock addition condition is not met, queue to wait to add the resource lock, and update the resource lock information, so that the updated resource lock information represents that the first node has joined the waiting node queue, monitor the resource lock information, until it is determined that the resource lock information meets a second resource lock addition condition, add the resource lock to the target resource, and update the resource lock information, so that the updated resource lock information represents that the resource lock is added to the target resource, and the first node is deleted from the waiting node queue.

In a possible implementation, the processor 2600 is specifically configured to:

obtain, from the first node, the resource lock information corresponding to the target resource, or obtain, from a second node, the resource lock information corresponding to the target resource.

In a possible implementation, the processor 2600 is specifically configured to:

determine the second node that stores the target resource; and obtain, from the second node, the resource lock information corresponding to the target resource.

In a possible implementation, the processor 2600 is specifically configured to:

determine, based on a primary-secondary node mapping relationship, that a primary node of the first node is the second node.

In a possible implementation, the processor 2600 is specifically configured to:

obtain, from the second node based on a remote direct memory access RDMA technology, the resource lock information corresponding to the target resource.

In a possible implementation, the resource lock information includes exclusive lock indication information, the waiting node queue, and a quantity of shared nodes. The exclusive lock indication information is used to indicate whether an exclusive lock is added to the target resource. The quantity of shared nodes is a quantity of nodes that have added a shared lock to the target resource. The waiting node queue includes an identifier of a node that requests to add the resource lock to the target resource, and the identifier of the node in the waiting node queue is arranged in a sequence of requesting to add the resource lock.

In a possible implementation, when the type of the resource lock is the exclusive lock, the first resource lock addition condition is as follows: The exclusive lock indication information indicates that no exclusive lock is added to the target resource, the quantity of shared nodes is 0, and the waiting node queue is empty; and the second resource lock addition condition is as follows: The exclusive lock indication information indicates that no exclusive lock is added to the target resource, the quantity of shared nodes is 0, and a node identifier of the first node is a first bit in the waiting node queue.

In a possible implementation, the resource lock information further includes a quantity of exclusive lock request nodes, and the quantity of exclusive lock request nodes is a quantity of nodes that request to add the exclusive lock in the waiting node queue.

The processor 2600 is specifically configured to:

add the node identifier of the first node to the waiting node queue, and increase the quantity of exclusive lock request nodes by one; or

update the exclusive lock indication information, decrease the quantity of exclusive lock request nodes by one, and delete the node identifier of the first node from the waiting node queue, where the updated exclusive lock indication information indicates that the exclusive lock is added to the target resource.

In a possible implementation, the waiting node queue further includes resource lock type indication information of each node. Resource lock type indication information of any node is used to indicate a type of a resource lock that the node requests to add.

The processor 2600 is specifically configured to:

add the node identifier of the first node and exclusive lock indication information of the first node to the waiting node queue; and

update the exclusive lock indication information, and delete the node identifier of the first node and the exclusive lock indication information of the first node from the waiting node queue, where the updated exclusive lock indication information indicates that the exclusive lock is added to the target resource.

In a possible implementation, when the resource lock is a shared lock, the resource lock information further includes a quantity of exclusive lock request nodes, and the quantity of exclusive lock request nodes is a quantity of nodes that request to add the exclusive lock in the waiting node queue.

The first resource lock addition condition is as follows:

The exclusive lock indication information indicates that no exclusive lock is added to the target resource, and the quantity of exclusive lock request nodes is 0. The second resource lock addition condition is as follows:

The exclusive lock indication information indicates that no exclusive lock is added to the target resource, and the node identifier of the first node is a first bit in the waiting node queue.

In a possible implementation, the processor 2600 is further configured to:

increase the quantity of shared nodes by one; or

increase the quantity of shared nodes by one, and delete the node identifier of the first node from the waiting node queue.

In a possible implementation, the resource lock information further includes a quantity of shared lock request nodes, and the quantity of shared lock request nodes is a quantity of nodes that request to add the shared lock in the waiting node queue.

The processor 2600 is specifically configured to:

add the node identifier of the first node to the waiting node queue, and increase the quantity of shared lock request nodes by one; or

increase the quantity of shared nodes by one, decrease the quantity of shared lock request nodes by one, and delete the node identifier of the first node from the waiting node queue.

In a possible implementation, when the resource lock is a shared lock, the waiting node queue further includes resource lock type indication information of each node. Resource lock type indication information of any node is used to indicate a type of a resource lock that the node requests to add.

The first resource lock addition condition is as follows:

The exclusive lock indication information indicates that no exclusive lock is added to the target resource, and the waiting node queue does not include a node whose corresponding resource lock type indication information indicates the exclusive lock.

The second resource lock addition condition is as follows:

The exclusive lock indication information indicates that no exclusive lock is added to the target resource, and the node identifier of the first node is a first bit in the waiting node queue.

In a possible implementation, the processor 2600 is specifically configured to:

increase, by the first node, the quantity of shared nodes by one; or increase the quantity of shared nodes by one, and delete the node identifier of the first node and resource lock type indication information of the first node from the waiting node queue.

In a possible implementation, the processor 2600 is further configured to:

release the exclusive lock from the target resource, and update the exclusive lock indication information, where the updated exclusive lock indication information indicates that no exclusive lock is added to the target resource.

In a possible implementation, the processor 2600 is further configured to:

release the shared lock from the target resource, and decrease the quantity of shared nodes by one.

As shown in FIG. 27, this application provides a resource lock management apparatus. The apparatus includes:

an obtaining module 2700, configured to: determine to add a resource lock to a target resource, and obtain resource lock information corresponding to the target resource, where the resource lock information is used to represent whether the resource lock is added to the target resource, and information about a waiting node queue that requests to add the resource lock, and a type of the resource lock is an exclusive lock or a shared lock; and

a processing module 2701, configured to: determine, based on the resource lock information, whether a first resource lock addition condition is met; and if the first resource lock addition condition is met, add the resource lock to the target resource, and update the resource lock information, so that the updated resource lock information represents that the resource lock is added to the target resource; or if the first resource lock addition condition is not met, queue to wait to add the resource lock, and update the resource lock information, so that the updated resource lock information represents that the first node has joined the waiting node queue, monitor the resource lock information, until it is determined that the resource lock information meets a second resource lock addition condition, add the resource lock to the target resource, and update the resource lock information, so that the updated resource lock information represents that the resource lock is added to the target resource, and the first node is deleted from the waiting node queue.

In a possible implementation, the obtaining module 2700 is specifically configured to:

obtain, from the first node, the resource lock information corresponding to the target resource, or obtain, from a second node, the resource lock information corresponding to the target resource.

In a possible implementation, the obtaining module 2700 is specifically configured to:

determine the second node that stores the target resource; and obtain, from the second node, the resource lock information corresponding to the target resource.

In a possible implementation the processing module 2701 is specifically configured to:

determine, based on a primary-secondary node mapping relationship, that a primary node of the first node is the second node.

In a possible implementation the processing module 2701 is specifically configured to:

obtain, from the second node based on a remote direct memory access RDMA technology, the resource lock information corresponding to the target resource.

In a possible implementation, the resource lock information includes exclusive lock indication information, the waiting node queue, and a quantity of shared nodes. The exclusive lock indication information is used to indicate whether an exclusive lock is added to the target resource. The quantity of shared nodes is a quantity of nodes that have added a shared lock to the target resource. The waiting node queue includes an identifier of a node that requests to add the resource lock to the target resource, and the identifier of the node in the waiting node queue is arranged in a sequence of requesting to add the resource lock.

In a possible implementation, when the type of the resource lock is the exclusive lock, the first resource lock addition condition is that the exclusive lock indication information indicates that no exclusive lock is added to the target resource, the quantity of shared nodes is 0, and the waiting node queue is empty; and the second resource lock addition condition is that the exclusive lock indication information indicates that no exclusive lock is added to the target resource, the quantity of shared nodes is 0, and a node identifier of the first node is a first bit in the waiting node queue.

In a possible implementation, the resource lock information further includes a quantity of exclusive lock request nodes, and the quantity of exclusive lock request nodes is a quantity of nodes that request to add the exclusive lock in the waiting node queue.

The processing module 2701 is specifically configured to:

add the node identifier of the first node to the waiting node queue, and increase the quantity of exclusive lock request nodes by one; or

update the exclusive lock indication information, decrease the quantity of exclusive lock request nodes by one, and delete the node identifier of the first node from the waiting node queue, where the updated exclusive lock indication information indicates that the exclusive lock is added to the target resource.

In a possible implementation, the waiting node queue further includes resource lock type indication information of each node. Resource lock type indication information of any node is used to indicate a type of a resource lock that the node requests to add.

The processing module 2701 is specifically configured to:

add the node identifier of the first node and exclusive lock indication information of the first node to the waiting node queue; and

update the exclusive lock indication information, and delete the node identifier of the first node and the exclusive lock indication information of the first node from the waiting node queue, where the updated exclusive lock indication information indicates that the exclusive lock is added to the target resource.

In a possible implementation, when the resource lock is a shared lock, the resource lock information further includes a quantity of exclusive lock request nodes, and the quantity of exclusive lock request nodes is a quantity of nodes that request to add the exclusive lock in the waiting node queue.

The first resource lock addition condition is as follows:

The exclusive lock indication information indicates that no exclusive lock is added to the target resource, and the quantity of exclusive lock request nodes is 0. The second resource lock addition condition is as follows:

The exclusive lock indication information indicates that no exclusive lock is added to the target resource, and the node identifier of the first node is a first bit in the waiting node queue.

In a possible implementation, the processing module 2701 is further configured to:

increase the quantity of shared nodes by one; or

increase the quantity of shared nodes by one, and delete the node identifier of the first node from the waiting node queue.

In a possible implementation, the resource lock information further includes a quantity of shared lock request nodes, and the quantity of shared lock request nodes is a quantity of nodes that request to add the shared lock in the waiting node queue.

The processing module 2701 is specifically configured to:

add the node identifier of the first node to the waiting node queue, and increase the quantity of shared lock request nodes by one; or

increase the quantity of shared nodes by one, decrease the quantity of shared lock request nodes by one, and delete the node identifier of the first node from the waiting node queue.

In a possible implementation, when the resource lock is a shared lock, the waiting node queue further includes resource lock type indication information of each node. Resource lock type indication information of any node is used to indicate a type of a resource lock that the node requests to add.

The first resource lock addition condition is as follows:

The exclusive lock indication information indicates that no exclusive lock is added to the target resource, and the waiting node queue does not include a node whose corresponding resource lock type indication information indicates the exclusive lock.

The second resource lock addition condition is as follows:

The exclusive lock indication information indicates that no exclusive lock is added to the target resource, and the node identifier of the first node is a first bit in the waiting node queue.

In a possible implementation the processing module 2701 is specifically configured to:

increase, by the first node, the quantity of shared nodes by one; or increase the quantity of shared nodes by one, and delete the node identifier of the first node and resource lock type indication information of the first node from the waiting node queue.

In a possible implementation, the processing module 2701 is further configured to:

release the exclusive lock from the target resource, and update the exclusive lock indication information, where the updated exclusive lock indication information indicates that no exclusive lock is added to the target resource.

In a possible implementation, the processing module 2701 is further configured to:

release the shared lock from the target resource, and decrease the quantity of shared nodes by one.

In some possible implementations, aspects of the resource lock management method provided in the embodiments of this application may also be implemented in a form of a program product, and the program product includes program code. When the program code is run on a computer device, the program code is used to enable the computer device to perform the steps in the resource lock management method described in this specification according to various example implementations of this application.

The program product may be any combination of one or more readable media. The readable medium may be a readable signal medium or a readable storage medium. The readable storage medium may be, for example, but is not limited to an electrical system, apparatus, or device, a magnetic system, apparatus, or device, an optical system, apparatus, or device, an electromagnetic system, apparatus, or device, an infrared system, apparatus, or device, or a semiconductor system, apparatus, or device, or any combination thereof. More specific examples (non-exhaustive list) of the readable storage media include: an electrical connection with one or more wires, a portable disk, a hard disk, a random access memory (RAM), a read-only memory (ROM), an erasable programmable read-only memory (EPROM or a flash memory), an optical fiber, a portable compact disk read-only memory (CD-ROM), an optical storage device, a magnetic storage device, or any proper combination thereof.

A resource lock management program product according to the implementations of this application may be a portable compact disk read-only memory (CD-ROM) and include program code and may run on a server device. However, the program product in this application is not limited thereto. In this specification, the readable storage medium may be any tangible medium including or storing a program, the program may be used by or in combination with an information transfer, apparatus, or device.

A readable signal medium may include some data signals propagated in a baseband or as a part of a carrier, and the readable signal medium carries readable program code. The propagated data signals may be in various forms, including but not limited to an electromagnetic signal, an optical signal, or any proper combination thereof. The readable signal medium may alternatively be any readable medium other than the readable storage medium, and the readable medium may send, propagate, or transfer a program to be used by or in combination with a periodic network action system, apparatus, or device.

The program code included in the readable medium may be transmitted through any proper medium, including but not limited to a wireless medium, a wired medium, an optical cable, an RF medium, or any proper combination thereof.

The program code for performing operations of this application may be written in any combination of one or more programming languages. The programming languages include object-oriented programming languages such as Java, C++, and the like, and further include a conventional procedural programming language such as “C” or a similar programming language. The program code may be executed on a user computing device, partially on a user device, as a separate software package, partially on a user computing device and partially on a remote computing device, or on a remote computing device or a server. In a case involving the remote computing device, the remote computing device may be connected to the user computing device through any type of network, including a local area network (LAN) or a wide area network (WAN), or may be connected to an external computing device.

An embodiment of this application further provides a computing device readable storage medium for a resource lock management method, so that content is not lost after power is off. The storage medium stores a software program, including program code. When the program code is run on a computing device, and the software program is read and executed by one or more processors, any resource lock management solution in the embodiments of this application may be implemented.

This application is described above with reference to the block diagrams and/or flowcharts of the method, the apparatus (system), and/or the computer program product according to the embodiments of this application. It should be understood that a computer program instruction may be used to implement a block of the block diagrams and/or the flowcharts and a combination of blocks of the block diagrams and/or the flowcharts. The computer program instruction may be provided for a general-purpose computer, a processor of a special-purpose computer, and/or other programmable data processing apparatus, to generate a machine, so that an instruction executed by a computer processor and/or another programmable data processing apparatus is used to create a method for implementing a function/an action specified in the block diagrams and/or the flowcharts.

Correspondingly, this application may be further implemented by using hardware and/or software (including firmware, resident software, microcode, and the like). Further, a form of a computer program product in a computer-useable or computer-readable storage medium may be used in this application, and the computer program product includes computer-useable or computer-readable program code implemented in the medium, so that the computer-useable or computer-readable program code may be used by or in combination with an instruction execution system. In a context of this application, the computer-useable or computer-readable medium may be any medium, may include, store, communicate, transmit, or transfer a program, so that the program is used by or in combination with an instruction execution system, apparatus, or device.

Although this application is described with reference to specific features and the embodiments thereof, it is clear that various modifications and combinations may be made to them without departing from the spirit and scope of this application. Correspondingly, the specification and accompanying drawings are merely example description of this application defined by the accompanying claims, and is considered as any of or all modifications, variations, combinations or equivalents that cover the scope of this application. It is clear that a person skilled in the art can make various modifications and variations to this application without departing from the scope of this application. This application is intended to cover these modifications and variations of this application provided that they fall within the scope of protection defined by the following claims and their equivalent technologies.

1. A resource lock management method, comprising:
determining, by a first node, to add a resource lock to a target resource;
obtaining, by the first node, resource lock information corresponding to the target resource, wherein the resource lock information is used to represent whether the resource lock is added to the target resource, and information about a waiting node queue that requests to add the resource lock, and wherein a type of the resource lock is an exclusive lock or a shared lock;
determining, by the first node based on the resource lock information, whether a first resource lock addition condition is met; and
if the first resource lock addition condition is met,
adding, by the first node, the resource lock to the target resource; and
updating the resource lock information as first updated resource lock information, wherein the first updated resource lock information represents that the resource lock is added to the target resource; or
if the first resource lock addition condition is not met,
queuing, by the first node, to wait to add the resource lock;
updating the resource lock information as second updated resource lock information, wherein the second updated resource lock information represents that the first node has joined the waiting node queue;
monitoring the resource lock information, until it is determined that the resource lock information meets a second resource lock addition condition;
adding the resource lock to the target resource; and
updating the resource lock information as third updated resource lock information, wherein the third updated resource lock information represents that the resource lock is added to the target resource, and that the first node is deleted from the waiting node queue.

2. The method according to claim 1, wherein the obtaining, by the first node, the resource lock information corresponding to the target resource comprises:
locally obtaining, by the first node, the resource lock information corresponding to the target resource; or
obtaining, by the first node from a second node, the resource lock information corresponding to the target resource.

3. The method according to claim 2, wherein the obtaining, by the first node from the second node, the resource lock information corresponding to the target resource comprises:
determining, by the first node, the second node that stores the target resource; and
obtaining, by the first node from the second node, the resource lock information corresponding to the target resource.

4. The method according to claim 3, wherein the determining, by the first node, the second node that stores the target resource comprises:
determining, by the first node based on a primary-secondary node mapping relationship, that a primary node of the first node is the second node.

5. The method according to claim 2, wherein the obtaining, by the first node from the second node, the resource lock information corresponding to the target resource comprises:
obtaining, by the first node from the second node based on a remote direct memory access (RDMA) technology, the resource lock information corresponding to the target resource.

6. The method according to claim 1, wherein the resource lock information comprises exclusive lock indication information, the waiting node queue, and a quantity of shared nodes, and wherein:
the exclusive lock indication information is used to indicate whether an exclusive lock is added to the target resource;
the quantity of shared nodes is a quantity of nodes that have added a shared lock to the target resource; and
the waiting node queue comprises an identifier of a node that requests to add the resource lock to the target resource, wherein the identifier of the node in the waiting node queue is arranged in a sequence of requesting to add the resource lock.

7. The method according to claim 6, wherein when the type of the resource lock is an exclusive lock,
the first resource lock addition condition is as follows:
the exclusive lock indication information indicates that no exclusive lock is added to the target resource;
the quantity of shared nodes is 0; and
the waiting node queue is empty; and
the second resource lock addition condition is as follows:
the exclusive lock indication information indicates that no exclusive lock is added to the target resource;
the quantity of shared nodes is 0; and
a node identifier of the first node is a first bit in the waiting node queue.

8. The method according to claim 7, wherein the resource lock information further comprises a quantity of exclusive lock request nodes, and the quantity of exclusive lock request nodes is a quantity of nodes that request to add the exclusive lock in the waiting node queue;
wherein the updating, by the first node, the resource lock information as the second updated resource lock information comprises:
adding, by the first node, the node identifier of the first node to the waiting node queue; and
increasing the quantity of exclusive lock request nodes by one; and
wherein the updating, by the first node, the resource lock information as the third updated resource lock information comprises:
updating, by the first node, the exclusive lock indication information as updated exclusive lock indication information;
decreasing the quantity of exclusive lock request nodes by one; and
deleting the node identifier of the first node from the waiting node queue, wherein the updated exclusive lock indication information indicates that the exclusive lock is added to the target resource.

9. The method according to claim 7, wherein the waiting node queue further comprises resource lock type indication information of each node, and resource lock type indication information of any node is used to indicate a type of a resource lock that the node requests to add;
wherein the updating, by the first node, the resource lock information as the second updated resource lock information comprises:
adding, by the first node, the node identifier of the first node and exclusive lock indication information of the first node to the waiting node queue; and
wherein the updating, by the first node, the resource lock information as the third updated resource lock information comprises:
updating, by the first node, the exclusive lock indication information as updated exclusive lock indication information; and
deleting the node identifier of the first node and the exclusive lock indication information of the first node from the waiting node queue, wherein the updated exclusive lock indication information indicates that the exclusive lock is added to the target resource.

10. A resource lock management apparatus, comprising:
at least one processor; and
one or more memories coupled to the at least one processor and storing programing instructions for execution by the at least one processor to:
determine to add a resource lock to a target resources;
obtain resource lock information corresponding to the target resource, wherein the resource lock information is used to represent whether the resource lock is added to the target resource, and information about a waiting node queue that requests to add the resource lock, and wherein a type of the resource lock is an exclusive lock or a shared lock;
determine, based on the resource lock information, whether a first resource lock addition condition is met; and
if the first resource lock addition condition is met,
add the resource lock to the target resource; and
update the resource lock information as first updated resource lock information, wherein the first updated resource lock information represents that the resource lock is added to the target resource; or
if the first resource lock addition condition is not met,
queue to wait to add the resource lock;
update the resource lock information as second updated resource lock information, wherein the second updated resource lock information represents that a first node has joined the waiting node queue;
monitor the resource lock information, until it is determined that the resource lock information meets a second resource lock addition condition;
add a resource lock to the target resource; and
update the resource lock information as third updated resource lock information, wherein the third updated resource lock information represents that the resource lock is added to the target resource, and that the first node is deleted from the waiting node queue.

11. The apparatus according to claim 10, wherein the one or more memories store the programming instructions for execution by the at least one processor to:
locally obtain the resource lock information corresponding to the target resource; or
obtain, from a second node, the resource lock information corresponding to the target resource.

12. The apparatus according to claim 11, wherein the one or more memories store the programming instructions for execution by the at least one processor to:
determine the second node that stores the target resource; and
obtain, from the second node, the resource lock information corresponding to the target resource.

13. The apparatus according to claim 12, wherein the one or more memories store the programming instructions for execution by the at least one processor to:
determine, based on a primary-secondary node mapping relationship, that a primary node of the first node is the second node.

14. The apparatus according to claim 11, wherein the one or more memories store the programming instructions for execution by the at least one processor to:
obtain, from the second node based on a remote direct memory access (RDMA) technology, the resource lock information corresponding to the target resource.

15. The apparatus according to claim 10, wherein the resource lock information comprises exclusive lock indication information, the waiting node queue, and a quantity of shared nodes, and wherein:
the exclusive lock indication information is used to indicate whether an exclusive lock is added to the target resource;
the quantity of shared nodes is a quantity of nodes that have added a shared lock to the target resource; and
the waiting node queue comprises an identifier of a node that requests to add the resource lock to the target resource, wherein the identifier of the node in the waiting node queue is arranged in a sequence of requesting to add the resource lock.

16. The apparatus according to claim 15, wherein when the type of the resource lock is an exclusive lock,
the first resource lock addition condition is as follows:
the exclusive lock indication information indicates that no exclusive lock is added to the target resource;
the quantity of shared nodes is 0; and
the waiting node queue is empty; and
the second resource lock addition condition is as follows:
the exclusive lock indication information indicates that no exclusive lock is added to the target resource;
the quantity of shared nodes is 0; and
a node identifier of the first node is a first bit in the waiting node queue.

17. The apparatus according to claim 16, wherein the resource lock information further comprises a quantity of exclusive lock request nodes, and the quantity of exclusive lock request nodes is a quantity of nodes that request to add the exclusive lock in the waiting node queue; and
wherein the update the resource lock information as the second updated resource lock information comprises:
add the node identifier of the first node to the waiting node queue; and
increase the quantity of exclusive lock request nodes by one; and
wherein the update the resource lock information as the third updated resource lock information comprises:
update the exclusive lock indication information as updated exclusive lock indication information;
decrease the quantity of exclusive lock request nodes by one; and
delete the node identifier of the first node from the waiting node queue, wherein the updated exclusive lock indication information indicates that the exclusive lock is added to the target resource.

18. The apparatus according to claim 16, wherein the waiting node queue further comprises resource lock type indication information of each node, and resource lock type indication information of any node is used to indicate a type of a resource lock that the node requests to add; and
wherein the update the resource lock information as the second updated resource lock information comprises:
add the node identifier of the first node and exclusive lock indication information of the first node to the waiting node queue; and
wherein the update the resource lock information as the third updated resource lock information comprises:
update the exclusive lock indication information; and
delete the node identifier of the first node and the exclusive lock indication information of the first node from the waiting node queue, wherein the updated exclusive lock indication information indicates that the exclusive lock is added to the target resource.

19. (canceled)

20. A non-transitory computer-readable storage medium, wherein the non-transitory computer-readable storage medium stores computer executable instructions for execution by at least one processor to:
determine to add a resource lock to a target resource;
obtain resource lock information corresponding to the target resource, wherein the resource lock information is used to represent whether the resource lock is added to the target resource, and information about a waiting node queue that requests to add the resource lock, and wherein a type of the resource lock is an exclusive lock or a shared lock;
determine, based on the resource lock information, whether a first resource lock addition condition is met; and
if the first resource lock addition condition is met,
add the resource lock to the target resource; and
update the resource lock information as first updated resource lock information, wherein the first updated resource lock information represents that the resource lock is added to the target resource; or
if the first resource lock addition condition is not met,
queue to wait to add the resource lock;
update the resource lock information as second updated resource lock information, wherein the second updated resource lock information represents that a first node has joined the waiting node queue;
monitor the resource lock information, until it is determined that the resource lock information meets a second resource lock addition condition;
add a resource lock to the target resource; and
update the resource lock information as third updated resource lock information, wherein the third updated resource lock information represents that the resource lock is added to the target resource, and that the first node is deleted from the waiting node queue.

21. The non-transitory computer-readable storage medium of claim 20, wherein the non-transitory computer-readable storage medium stores the computer executable instructions—for execution by the at least one processor to:
locally obtain the resource lock information corresponding to the target resource; or
obtain, from a second node, the resource lock information corresponding to the target resource.
